(19) United States
(12) Patent Application Publication
(10) Pub. No.: US 2026/0260383 A1
(43) Pub. Date: Sep. 3, 2026

(54) Topology Encoding

(71) Applicant: Imagination Technologies Limited, Kings Langley (GB)

(72) Inventor: Peter Smith-Lacey, Hertfordshire (GB)

(21) Appl. No.: 19/542,863

(22) Filed: Feb. 18, 2026

(30) Foreign Application Priority Data
Feb. 18, 2025 (GB) 2502384.7

(51) Int. Cl. G06T 9/00

(52) U.S. Cl. CPC G06T 9/001

(57) ABSTRACT

A method of compressing meshlet topology data includes selecting a starting vertex in a meshlet and creating an encoding comprising data identifying a glue type of the starting vertex and data indicating a number of connected vertices. A next glue vertex in the meshlet is then selected and for the next glue vertex, the method comprises appending to the encoding, one or more of: data identifying the next glue vertex; data identifying a glue type of the next glue vertex and data indicating a number of new connected vertices, wherein each new connected vertex is connected to the new glue vertex by an edge. The method continues to select a next glue vertex and append one or more bits to the encoding until all the vertices and edges of the meshlet are included in the encoding. Methods and apparatus for decompression are also described.

### CROSS-REFERENCE TO RELATED APPLICATIONS AND CLAIM OF PRIORITY

This application claims foreign priority under 35 USC 119 from United Kingdom patent application No. 2502384.7 filed on 18 Feb. 2025, the contents of which are incorporated by reference herein in their entirety.

### TECHNICAL FIELD

The invention is related to the compression and decompression of meshlet topology data.

### BACKGROUND

In computer graphics, 3D scenes and objects are represented as a mesh of 2D primitives, which are typically triangular in shape. Each primitive is represented by its vertices and its edges, which connect pairs of vertices. Coordinate data defines the coordinates of each vertex and topology data defines how the primitives are connected together. These meshes can be very large, i.e. comprise a very large number of primitives, and hence require significant graphics processing resources to render them.

In order to improve the efficiency of graphics processing, the mesh may be sub-divided into a plurality of meshlets. Each meshlet usually contains a limited number of vertices and/or primitives, and this limit is generally smaller than an entire mesh for an object/model, and use of meshlets provides greater flexibility in how the geometry is processed through various techniques such as use of mesh shaders, increased parallelism, more efficient culling, etc.

The embodiments described below are provided by way of example only and are not limiting of implementations which solve any or all of the disadvantages of known methods of storing meshlet topology data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of compressing meshlet topology data is described. The method comprises selecting a starting vertex in a meshlet and creating an encoding comprising data identifying a glue type of the starting vertex and data indicating a number of connected vertices. A next glue vertex in the meshlet is then selected and for the next glue vertex, the method comprises appending to the encoding, one or more of: data identifying the next glue vertex; data identifying a glue type of the next glue vertex and data indicating a number of new connected vertices, wherein each new connected vertex is connected to the new glue vertex by an edge. The method continues to select a next glue vertex and append one or more bits to the encoding until all the vertices and edges of the meshlet are included in the encoding. Methods and apparatus for decompression are also described.

A first aspect provides a method of compressing meshlet topology data comprising: (i) selecting a starting vertex in a meshlet; (ii) create an encoding comprising data identifying a glue type of the starting vertex and data indicating a number of connected vertices, wherein the glue type of a vertex defines a relative arrangement of the vertex and the connected vertices and wherein each connected vertex is connected to the starting vertex by an edge; (iii) selecting a next glue vertex in the meshlet; (iv) for the next glue vertex, appending to the encoding, one or more of: data identifying the next glue vertex; data identifying a glue type of the next glue vertex and data indicating a number of new connected vertices, wherein each new connected vertex is connected to the new glue vertex by an edge; and (v) repeating steps (iii) and (iv) until all the vertices and edges of the meshlet are included in the encoding.

A second aspect provides a method of decompressing compressed meshlet topology data comprising: (i) reading a first sequence of bits from an encoding of a meshlet; (ii) determining, from the sequence of bits, a glue type of a starting vertex and data indicating a number of connected vertices, wherein the glue type of a vertex defines a relative arrangement of the vertex and the connected vertices and wherein each connected vertex is connected to the starting vertex by an edge; (iii) adding the identified number of connected vertices to the starting vertex to form a portion of the meshlet, the portion of the meshlet comprising a plurality of primitives, and storing intermediate data for the portion of the meshlet; (iv) reading a next sequence of bits from the encoding; (v) determining, from the sequence of bits and the intermediate data, a glue vertex in the portion of the meshlet, a glue type of the glue vertex and data indicating a number of new connected vertices, wherein each connected vertex is connected to the glue vertex by an edge; (vi) adding the identified number of new connected vertices to the portion of the meshlet according to the glue type of the glue vertex, and updating intermediate data for the portion of the meshlet; (vii) repeating steps (iv)-(vi) until the sequence or the intermediate data indicates termination; (viii) outputting the decompressed meshlet topology data.

A third aspect provides hardware logic (which may be referred to as ‘decompression hardware logic block’) arranged to decompress compressed meshlet topology data comprising: a first hardware logic block arranged to read a first sequence of bits from an encoding of a meshlet; a second hardware logic block arranged to determine, from the sequence of bits received from the first hardware logic block, a glue type of a starting vertex and data indicating a number of connected vertices, wherein the glue type of a vertex defines a relative arrangement of the vertex and the connected vertices and wherein each connected vertex is connected to the starting vertex by an edge; a third hardware logic block arranged to add the identified number of connected vertices to the starting vertex to form a portion of the meshlet, the portion of the meshlet comprising a plurality of primitives, and a fourth hardware logic block arranged to generate and store intermediate data for the portion of the meshlet, wherein the first hardware logic block is further arranged to read a next sequence of bits from the encoding, the second hardware logic block is further arranged to determine, from the next sequence of bits and the intermediate data, a glue vertex in the portion of the meshlet, a glue type of the glue vertex and data indicating a number of new connected vertices, wherein each connected vertex is connected to the glue vertex by an edge, the third hardware logic block is further arranged to add the identified number of new connected vertices to the portion of the meshlet according to the glue type of the glue vertex, and the fourth hardware logic block is further arranged to generate and store updated intermediate data for the portion of the meshlet.

A fourth aspect provides a graphics processing unit comprising the decompression hardware logic block described above.

A fifth aspect provides computer readable code configured to cause the methods of compressing meshlet topology data as described herein to be performed when the code is run.

A sixth aspect provides computer readable code configured to cause the methods of decompressing compressed meshlet topology data as described herein to be performed when the code is run.

The decompression hardware logic block may be embodied in hardware on an integrated circuit. There may be provided a method of manufacturing, at an integrated circuit manufacturing system, decompression hardware logic block. There may be provided an integrated circuit definition dataset that, when processed in an integrated circuit manufacturing system, configures the system to manufacture decompression hardware logic block. There may be provided a non-transitory computer readable storage medium having stored thereon a computer readable description of decompression hardware logic block that, when processed in an integrated circuit manufacturing system, causes the integrated circuit manufacturing system to manufacture an integrated circuit embodying decompression hardware logic block.

There may be provided an integrated circuit manufacturing system comprising: a non-transitory computer readable storage medium having stored thereon a computer readable description of the decompression hardware logic block; a layout processing system configured to process the computer readable description so as to generate a circuit layout description of an integrated circuit embodying the decompression hardware logic block; and an integrated circuit generation system configured to manufacture the decompression hardware logic block according to the circuit layout description.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 shows two example meshlets;

FIG. 2 shows stretched versions of the two example meshlets from FIG. 1;

FIG. 3 is a flow diagram of a first example of a method of lossless compression of meshlet topology data;

FIG. 4 shows another example meshlet;

FIG. 5 shows a schematic diagram of the structure of an encoding of a meshlet;

FIG. 6 is a graphical representation of a first stage of compression of the meshlet of FIG. 4 according to a first example;

FIGS. 7-10 are graphical representations of four different glue types;

FIG. 11 is a graphical representation of a second stage of compression of the meshlet of FIG. 4 according to a first example;

FIG. 12 is a graphical representation of a third stage of compression of the meshlet of FIG. 4 according to a first example;

FIG. 13 is a graphical representation of a fourth stage of compression of the meshlet of FIG. 4 according to a first example;

FIG. 14 is a graphical representation of a fifth stage of compression of the meshlet of FIG. 4 according to a first example;

FIG. 15 is a flow diagram of a first example of a method of lossless compression of meshlet topology data;

FIG. 16 is a graphical representation of a first stage of compression of the meshlet of FIG. 4 according to a second example;

FIG. 17 is a graphical representation of a second stage of compression of the meshlet of FIG. 4 according to a second example;

FIG. 18 is a graphical representation of a third stage of compression of the meshlet of FIG. 4 according to a second example;

FIG. 19A is a graphical representation of a fourth stage of compression of the meshlet of FIG. 4 according to a second example;

FIG. 19B is a graphical representation of a fifth stage of compression of the meshlet of FIG. 4 according to a second example;

FIG. 20 is a graphical representation of a sixth stage of compression of the meshlet of FIG. 4 according to a second example;

FIG. 21 is a flow diagram of an example of a method of lossless decompression of compressed meshlet topology data;

FIG. 22 is a graphical representation of a first stage of decompression for an example meshlet;

FIG. 23 is a graphical representation of a second stage of decompression for an example meshlet;

FIG. 24 is a graphical representation of a third stage of decompression for an example meshlet;

FIG. 25 is a graphical representation of a fourth stage of decompression for an example meshlet;

FIG. 26 is a graphical representation of a fifth stage of decompression for an example meshlet;

FIG. 27 is a graphical representation of a first stage of decompression for another example meshlet;

FIG. 28 is a graphical representation of a second stage of decompression for another example meshlet;

FIG. 29 is a graphical representation of a third stage of decompression for another example meshlet;

FIG. 30 is a graphical representation of a fourth stage of decompression for another example meshlet;

FIG. 31 is a graphical representation of a fifth stage of decompression for another example meshlet;

FIG. 32 is a graphical representation of a sixth stage of decompression for another example meshlet;

FIG. 33A shows a computer system in which a graphics processing system that can perform the compression and/or decompression methods described herein is implemented;

FIG. 33B shows a more detailed graphical representation of the decompression hardware block in FIG. 33A; and

FIG. 34 shows an integrated circuit manufacturing system for generating an integrated circuit embodying a graphics processing system that can perform the compression and/or decompression methods described herein.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

As described above, in order to improve the efficiency of graphics processing, the mesh of primitives for a scene or object may be sub-divided into a plurality of meshlets, where each meshlet contains a limited number of vertices and primitives. Meshlets provide a coarser granularity to process and cull geometry (e.g. compared to processing of individual primitives). Additionally, in some implementations, meshlets are able to be generated on-the-fly (i.e. at runtime) using mesh shaders (possibly accompanied by task shaders).

Meshlet topologies (as distinct from the coordinate data) are typically stored as vertex data and a local index buffer storing a list of primitives in the form of triples of local vertex indices. This format contains some redundancy and is fixed length (for a given number of primitives), and therefore can benefit from lossless compression in at least two ways (i.e. removing redundancy and/or using variable length encoding). Furthermore, as this format does not include explicit edge representations, additional processing is required to derive this information when the edge topology data is used to render a scene. If, alternatively, the meshlet topology data included explicit edge representations in a hierarchical manner (e.g. edges as pairs of local vertices, primitives as triples of local edge indices), then the format becomes heavily verbose and more redundant whilst remaining uncompressed. The increased redundancy arises, at least in part, because the storage format is capable of storing many states (i.e. topologies) that are never found in real data (e.g. because they relate to topology that is not possible because not all primitives, as sets of edges, are possible) and because if duplicate vertex coordinates are used then many combinations of topology are degenerate.

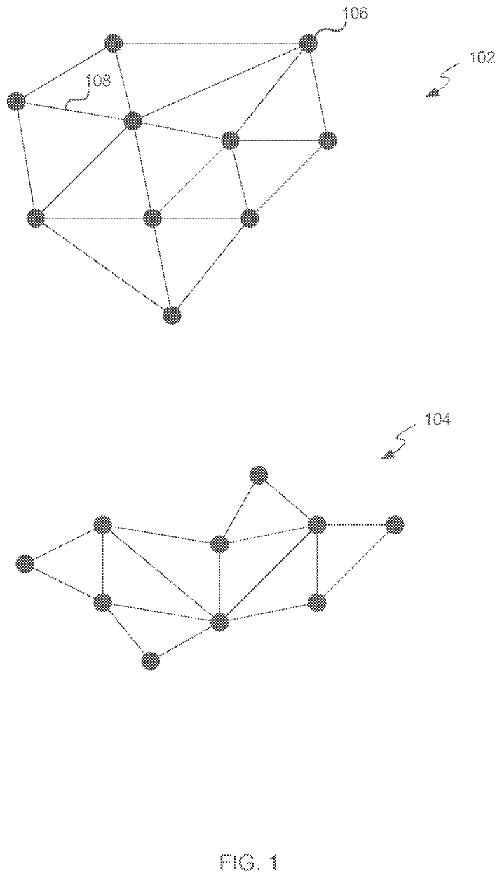

Described herein are methods of lossless compression and decompression of meshlet topology data. The compression method may also be referred to as an encoding method since the compressed meshlet topology data is referred to as an encoding and similarly, the decompression method may also be referred to as a decoding method. Each encoding, as generated in the compression/encoding method, comprises a series of bits from which the topology of the meshlet (i.e. the connectivity of the vertices and edges within the meshlet) can be determined. The methods described herein use shorter encodings (i.e. encodings comprising fewer bits) for meshlets that are more probable outputs from mesh segmentation algorithms (i.e. algorithms that split a mesh into a plurality of meshlets) compared to less probably outputs. The methods described herein also use shorter encodings for those meshlets that involve higher geometry re-use (i.e. in the form of more shared vertices and edges) compared to those with lower geometry re-use (i.e. fewer shared vertices and edges). FIG. 1 shows two example meshlets 102, 104 both of which comprise 10 vertices 106; however, the first meshlet 102 involves higher geometry re-use than the second meshlet 104. In the first meshlet 102, there are 13 shared edges 108 and all 10 vertices are shared. In the second meshlet 104, there are only 7 shared edges and only 6 vertices are shared.

The methods described herein provide reduced redundancy compared to existing methods as well as a high compression rate (e.g. as a consequence of using shorter encodings for more probable mesh topologies) which results in a significant reduction in ray bandwidth/storage overheads or more vertices per geometry block given a fixed size. The method does not involve a hard limit on the number of primitives or edges within a meshlet and instead there is a pre-defined maximum number of vertices in a meshlet (i.e. an upper limit on the number of vertices in a meshlet). This maximum number of vertices in a meshlet determines an upper limit on the amount of coordinate data that needs to be read and an upper limit on the number of states there are for a vertex encoding worst case (which determines how many bits to read/write in decompression/compression). In alternative examples where there is no pre-defined maximum number of vertices, the actual number of vertices in a meshlet is instead stored (e.g. in the encoding or elsewhere, such as in a header).

The nature of the encoding means that the topology data and in particular data about edges (including shared edges) is more readily available during decompression. This reduces the latency and the processing effort required to perform decompression as well as the amount of storage that is required (e.g. because it is not necessary to store and process the data for the entire meshlet to infer the edge information). For example, where the generated primitives are then rasterized, this enables the system to be pipelined so that primitives can be decompressed at a fixed rate (in terms of cycles) to be consumed by later stages (e.g. projection, etc.). Where ray tracing is used, it is possible to generate vertex data, then edge data, then primitive data in sequence and so, for a ray versus mesh intersection tester, for example, the overall computation requirement is reduced because per-vertex, per-edge and per-primitive operations can be performed in order, dropping the subsequent operations when a definite miss has been established (e.g. as described in GB2315020.4).

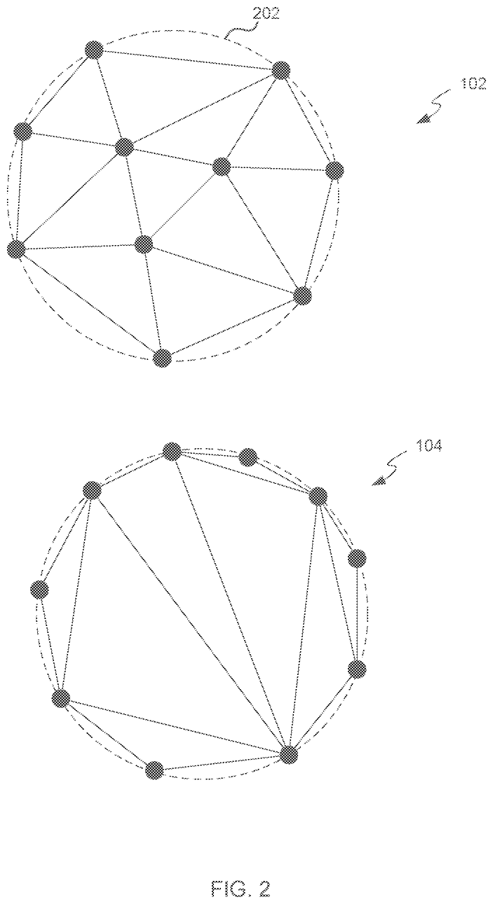

The methods described herein may be used for any meshlet that is homeomorphic to the topologically closed unit disc. In particular, the methods described herein may be used for any meshlet that is orientable and has a boundary that is homeomorphic to the unit circle. This means that the boundary can be transformed into a circle 202 by continuous deformations (such as stretching or bending), without tearing or gluing. This is demonstrated in FIG. 2 for the two meshlets 102, 104 shown in FIG. 1. For other meshlets, such as meshlets which are disconnected, are connected only by a vertex, or have 3+ triangles connected at an edge (such that they do not locally form a 2D plane), or have a hole within the mesh, or are closed or non-orientable, the meshlet needs to first be split into two or more smaller meshlets that satisfy the requirements for using this method. In some examples, a mesh segmentation algorithm may ensure that all the generated meshlets are homeomorphic to the topologically closed unit disc. In other examples an algorithm may be used to detect whether the meshlet is homeomorphic to the topologically closed unit disc.

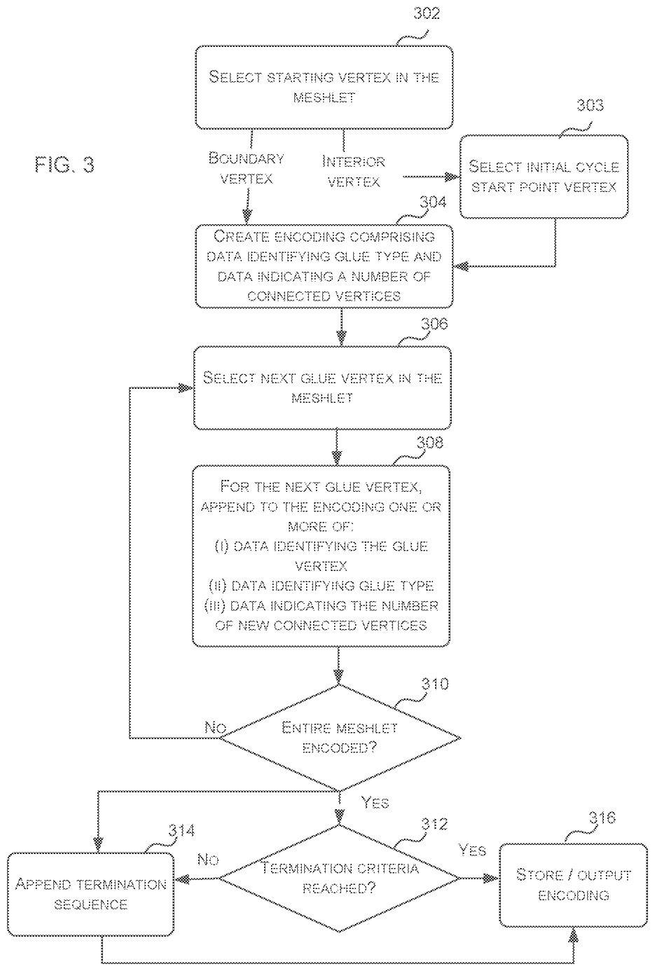

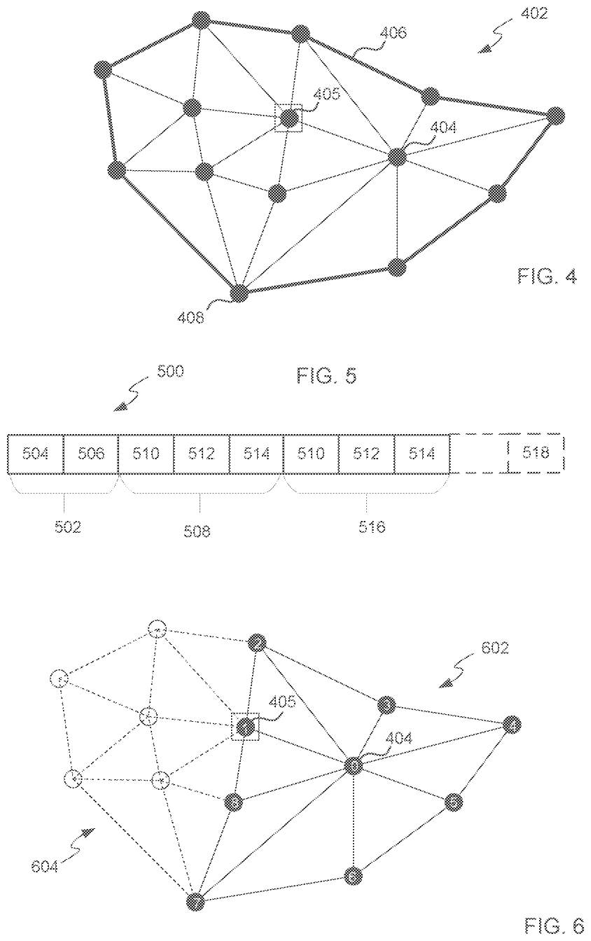

FIG. 3 is a flow diagram of a first example of the method of lossless compression of meshlet topology data and this can be described with reference to the meshlet 402 shown in FIG. 4. The method starts by selecting a starting vertex within the meshlet (block 302) and then iteratively adding sequences of bits to a string of bits (referred to as the encoding) until the string describes the entire meshlet. The starting vertex may be selected at random or selected based on pre-defined selection criteria or rules (as described in more detail below). In the example shown in FIG. 4, vertex 404 in the meshlet 402 is selected as the starting vertex. If the selected starting vertex (from block 302) is an interior vertex, as it is in this example, an initial cycle start point vertex is also selected (block 303), e.g. vertex 405 in meshlet 402 is selected as the initial cycle start point vertex (as indicated by the square around the vertex in FIG. 6). The initial cycle start point vertex may be selected using the same pre-defined selection criteria or rules as are used to select the starting vertex.

Having selected the starting vertex (in block 302) and, where required, the initial cycle start point vertex (in block 303), the first part of the encoding 500 is created (block 304). FIG. 5 shows a schematic diagram of the structure of the encoding of the meshlet. This first part 502 of the encoding 500 comprises a portion 504 that identifies a glue type of the starting vertex and a portion 506 that indicates a number of connected vertices. These connected vertices are other vertices in the meshlet that are connected to the starting vertex by an edge. In the example shown in FIG. 4, there are 8 vertices connected to the starting vertex by an edge. The number of connected vertices for a starting vertex may be two or more, whereas for subsequent glue vertices, there may be zero or more connected vertices, as described in detail below. The term ‘glue vertex’ is used herein to refer to a vertex relative to which a further portion of the meshlet can be defined in a next part of the encoding.

The term ‘glue type’ is used herein to define the vertex in terms of the topology that is connected to it within the meshlet, i.e. the glue type defines the relative arrangement of the vertex and those vertices that are connected to it via respective edges. A glue type therefore indicates whether the vertex is an interior vertex (i.e. it is in the middle of the meshlet and not on the boundary 406 of the meshlet) or whether the vertex is a boundary vertex (i.e. it is on the boundary of the full meshlet). Referring to FIG. 4, vertex 404 is an interior vertex whereas vertex 408 is a boundary vertex and the edges which form the boundary 406 of the full meshlet are shown by thicker lines than those edges which are internal to the meshlet.

The glue type may additionally indicate for the starting vertex, how many connected vertices there are (or a minimum number of connected vertices). For subsequent glue vertices, the glue type may additionally indicate whether and/or how many new vertices (i.e. vertices that have not previously been referenced in the encoding) are connected to the glue vertex and this is described in more detail below. By including this information within the glue type, it may enable additional compression (e.g. because it may not be necessary to include other information within the encoding or because it may reduce the length of the bit string that indicates the number of connected vertices, as described below).

For a starting vertex, there are two possible glue types: either the starting vertex is an ‘interior initial vertex with three or more connected vertices’ or the starting vertex is a ‘boundary initial vertex with two or more connected vertices’. Referring to the example shown in FIG. 4, it can be seen that vertex 404 is the first of these two types; however, if vertex 408 was instead selected as the starting vertex (in block 302), it would be of the second of these two types. As there are only two possible glue types, this may be encoded using a single bit and hence the first portion 504 of the first part 502 of the encoding 500 may comprise one bit. In an example, the two types may be encoded as indicated in the table below, although it will be appreciated that other encodings may alternatively be used:

| 1-bit | Glue | |
|---|---|---|
| encoding | type | Glue type description |
| 0 | I3+ | Interior initial vertex with |
| | | three or more connected vertices |
| 1 | B2+ | Boundary initial vertex with |
| | | two or more connected vertices |

As described above, the second portion 506 of the first part of the encoding 500 indicates a number of vertices connected to the starting vertex. The absolute number of connected vertices may be encoded (e.g. 1000 which is 8 in binary) or alternatively, this may be a relative value which is dependent upon the glue type. For example, where the starting vertex is an ‘interior initial vertex with three or more connected vertices’ (I3+), the encoded value (in portion 506) may be the number of connected vertices minus three (as, for this glue type, this is the smallest possible number of connected vertices). Similarly, where the starting vertex is a ‘boundary initial vertex with two or more connected vertices’ (B2+), the encoded value (in portion 506) may be the number of connected vertices minus two (as, for this glue type, this is the smallest possible number of connected vertices). By using a relative value in this way, the length of the encoding may be reduced, particularly at later stages in the compression method. The length of this second portion 506 is such that it could encode the maximum possible number of connected vertices, Vₘₐₓ−1 (e.g. 14−1=13, which requires four bits in either relative or absolute form).

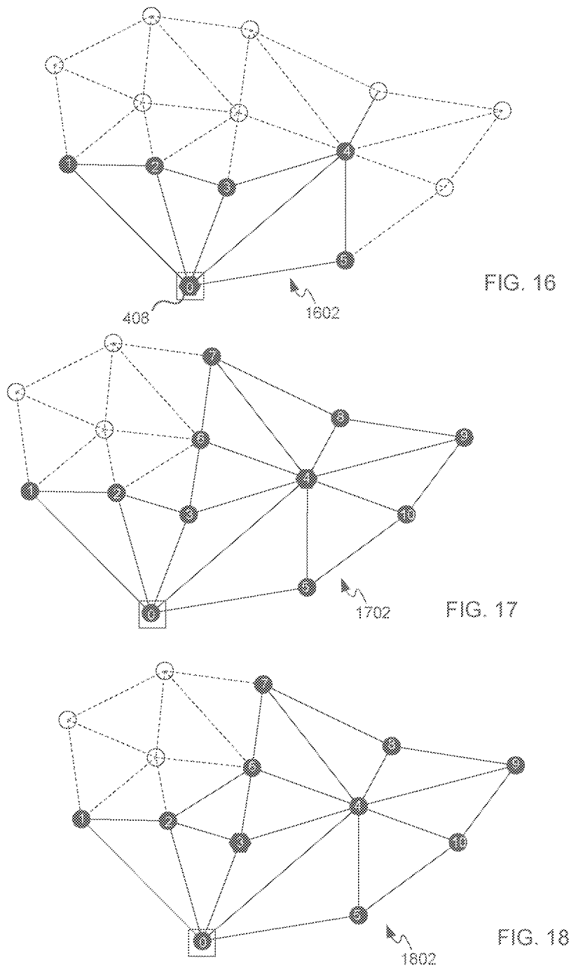

For the example shown in FIG. 4, the initial encoding (as created in block 304) is therefore: 00101, portioned as 0|0101 (where the first part 504 is 0 and the second part 506 is 0101). This initial encoding describes the portion 602 of the meshlet shown in FIG. 6 using solid lines and solid circles (with vertex indices shown in the solid circles), but does not describe the portion 604 of the meshlet shown using dotted lines or non-filled circles. As the starting vertex was an interior vertex, the initial encoding also does not define whether any of the edges (shown by the solid lines) are on the boundary of the full meshlet (and hence they are not shown by thicker outer lines as they are in FIG. 4). However, had the starting vertex been a boundary initial vertex, the initial encoding would have defined two edges are being boundaries of the full meshlet (e.g. as described below with reference to FIGS. 16-20). The term ‘full meshlet’ is used herein to refer to the entire meshlet 402 which is surrounded by the final boundary as shown in FIG. 4 to distinguish it from the encoded portion 602 shown in FIG. 6 for which at least some of the edges are not part of the final boundary.

The portion of the meshlet that is encoded by the initial encoding comprises V vertices, E edges, F primitives and B vertices on the boundary of the encoded portion. Where the starting vertex is an ‘interior initial vertex with three or more connected vertices’, then V=v+1, where v is the number of (new) connected vertices (and v≥3), E=2v, F=v and B=v. Where the starting vertex is a ‘boundary initial vertex with two or more connected vertices’, then V=v+1, where v is the number of (new) connected vertices (and v≥2), E=2v−1, F=v−1 and B=v+1.

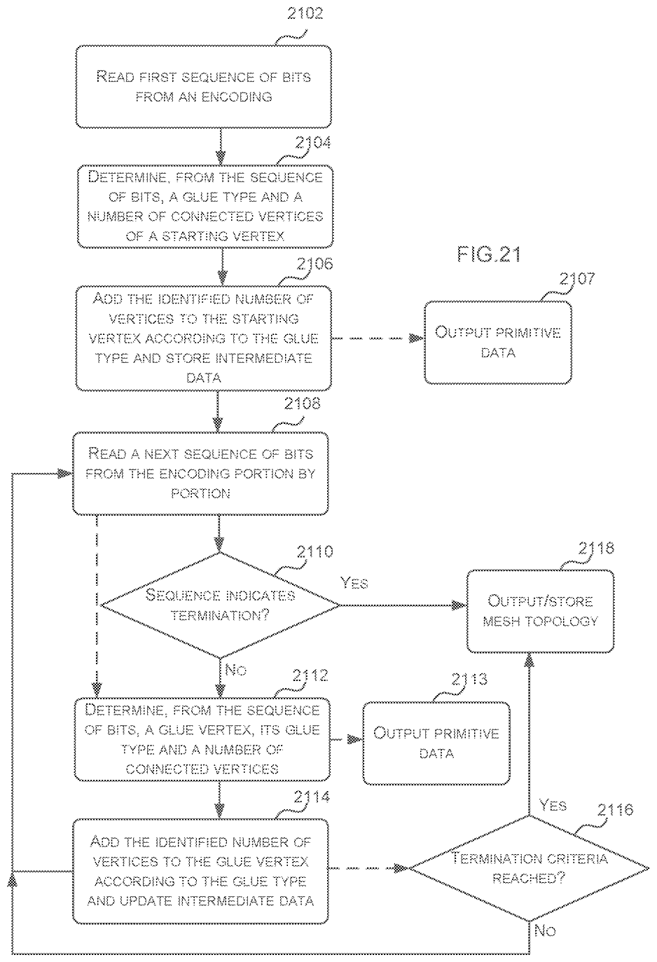

When performing compression (as in the method of FIG. 3), the values of V and B are tracked and the values of E and F may be tracked. B indicates how many sets of min/max values per glue type to store as the method progresses. V indicates how many more vertices could be glued on, compared to the pre-defined maximum number of vertices (by considering the difference). In contrast, for a subsequent decompression operation (e.g. as described below with reference to FIG. 21), the values of V, E and B are tracked and the value of F may be tracked. The value of E is used in the decompression operation to generate edge indices. Instead of tracking all of V, E, F and B, in some implementations a minimum of two values from the set {V, E, F, B} may be stored and the remaining values may be derived, as shown in the table below.

| INDEPENDENT | DEPENDENT | DEPENDENT |
|---|---|---|
| SET | VALUE 1 | VALUE 2 |
| {V, E} | F = −V + E + 1 | B = 3V − E − 3 |
| {V, F} | E = V + F − 1 | B = 2V − F − 2 |
| {V, B} | E = 3V − B − 3 | F = 2V − B − 2 |
| {E, F} | V = E − F + 1 | B = 2E − 3F |
| {E, B} | V = (E + B)/3 + 1 | F = (2E − B)/3 |
| {F, B} | V = (F + B)/2 + 1 | E = (3F + B)/2 |

Additionally, for both compression and decompression, the indices of the boundary vertices and their order (starting at the cycle start point vertex) is stored along with, for each boundary vertex, information on the available glue types and the maximum number of vertices available per glue type (for that boundary vertex). This information for a boundary vertex may be stored as: the minimum and maximum number of interior vertices, I, that could be connected to that vertex, the minimum and maximum number of vertices on its left boundary, L, that could be connected to that vertex and the minimum and maximum number of vertices on its right boundary, R, that could be connected to that vertex. In other examples, the information may be stored in a different way, such as a bit indicating whether the glue type I0 is available or not and, for each of the glue types I1+, L1+ and R1+: a maximum number of vertices for the particular glue type (there is an implicit minimum of one vertex as a consequence of the glue type), plus an invalid state for the maximum or a separate bit to indicate when the particular glue type is not available (i.e. not possible). This latter representation is slightly more compact than storing values of minimum and maximum values of I, L and R for each boundary vertex.

The method of FIG. 3 then continues by selecting a glue vertex in the meshlet (block 306). The glue vertex is selected from vertices that have already been described in the initial encoding (e.g. those vertices that are connected to the starting vertex, which are shown as solid circles in FIG. 6). The further portion of the meshlet may be a single primitive or a fan of primitives (e.g. where the primitives are triangles in the examples shown). A fan of primitives is a strip of primitives with a common vertex, which is the glue vertex.

Having selected a glue vertex (in block 306), a next part 508 of the encoding 500 is appended to the partial encoding that has already been created (in block 304). This next part 508 comprises one or more of the following: data identifying the glue vertex (portion 510), data identifying the glue type of the glue vertex (portion 512) and data indicating the number of new connected vertices (portion 514). As described above, new connected vertices are vertices which are connected to the glue vertex that have not previously been referenced in the encoding that has been formed so far by the compression method. Where any one of data identifying the glue vertex (portion 510), data identifying the glue type of the glue vertex (portion 512) and data indicating the number of new connected vertices (portion 514) is not included in the next part 508, then the corresponding parameter (i.e. glue vertex, glue type or number of new connected vertices) can instead be inferred (when performing decompression) from the data that is included and/or additional data that is available for the meshlet (e.g. tracked values of V, E, F and B or other intermediate data that is stored).

Where the starting vertex is an ‘interior initial vertex with three or more connected vertices’ (I3+), then any of the connected vertices can be selected as the first glue vertex because all vertices are identical (and selecting any particular one may just result in a re-orientation of the meshlet compared to the orientation shown in FIG. 4). This means that data identifying the glue vertex (portion 510) may be omitted from the next part 508 of the encoding. However, where the starting vertex is a ‘boundary initial vertex with two or more connected vertices’ (B2+), then the first glue vertex is selected according to a pre-defined set of rules and it is identified in the next part 508 of the encoding (i.e. portion 510 is not omitted). By using a pre-defined set of rules for this selection, the amount of compression that can be achieved is increased because it reduces the information that needs to be included in the encoding to enable the decompression method to reconstruct the entire meshlet topology, i.e. information about how the glue vertex is selected need not be encoded as the decompression method relies upon the use of the same pre-defined set of rules.

For a glue vertex, there are a maximum of four or five possible glue types, however, as a consequence of the pre-defined set of rules as the method progresses by selecting subsequent glue vertices (in subsequent iterations of the loop comprising blocks 306-310) some of these glue types may not be possible (as a consequence of the pre-defined set of rules) and this is described below. Four possible glue types are shown in the table below with an example two-bit encoding and in some implementations only these four glue types may be used. In some implementations there may be an additional fifth glue type which is a combination of the last two glue types in the table (boundary glue vertex with one or more new connected vertices added on the left and one or more new connected vertices added on the right). It will be appreciated that other encodings may alternatively be used and it will be appreciated that the terms “left” and “right” (in the third and fourth glue types below) are relative and may be defined in any way as long as they are defined and used consistently (e.g. meaning “previous” and “next” along the current boundary of a meshlet in a clockwise orientation) within both the compression and decompression methods:

| 2-bit | Glue | |
|---|---|---|
| encoding | type | Glue type description |
| 00 | I0 | Interior glue vertex with no new connected vertices |
| 01 | I1+ | Interior glue vertex with one or more new connected |
| | | vertices |
| 10 | L1+ | Boundary glue vertex with one or more new connected |
| | | vertices added on the left (meaning connected to the |
| | | previous but not next vertex along the boundary |
| | | clockwise) |
| 11 | R1+ | Boundary glue vertex with one or more new connected |
| | | vertices added on the right (meaning connected to |
| | | the next but not previous vertex along the boundary |
| | | clockwise) |

In some implementations there may be an additional fifth glue type which is a combination of the last two glue types in the table (boundary glue vertex with one or more new connected vertices added on the left and one or more new connected vertices added on the right). However, use of only the four encoding types as in the table above results in a shorter encoding when only one of the two is required (i.e. one or more connected vertices added on either the left or the right) and adding vertices on both the left and right sides is relatively uncommon and can instead be handled by two stages of encoding in implementations where just four encoding types are used.

The 2-bit encodings shown in the table above are the longest encodings for glue type. Where one or more of these glue types are not possible (as a consequence of the particular stage in encoding that has been reached), then reduced length encodings may be used instead. For example, where only the last two glue types are possible, only a single bit encoding may be used to encode whether the new connected vertices are added on the left or right. If there is only a single glue type which a particular vertex can have, then no glue type encoding is required.

These four glue types can be described with reference to FIGS. 7-10. In these diagrams the glue types are demonstrated with reference to the initial portion 602 of the meshlet shown in FIG. 6, although it will be appreciated that they may not be part of the meshlet 402 shown in FIG. 4.

FIG. 7 shows a glue vertex 702 (as indicated by a solid hexagon) which is of the first type in the table above (I0), i.e. an ‘interior glue vertex with no new connected vertices’ (V:=V, i.e. V becomes equal to V). If the glue vertex has this type, then it implicitly specifies a new edge 704 (indicated by the dashed line) which connects two vertices that are connected to the glue vertex (E:=E+1), where these two vertices are not new vertices but are vertices that have already been referenced in the part of the encoding that has already been created. It also increases the number of primitives that have been encoded so far by one (F:=F+1) and reduces the number of boundary vertices by one, as the glue vertex 702 is no longer on the boundary (B:=B−1).

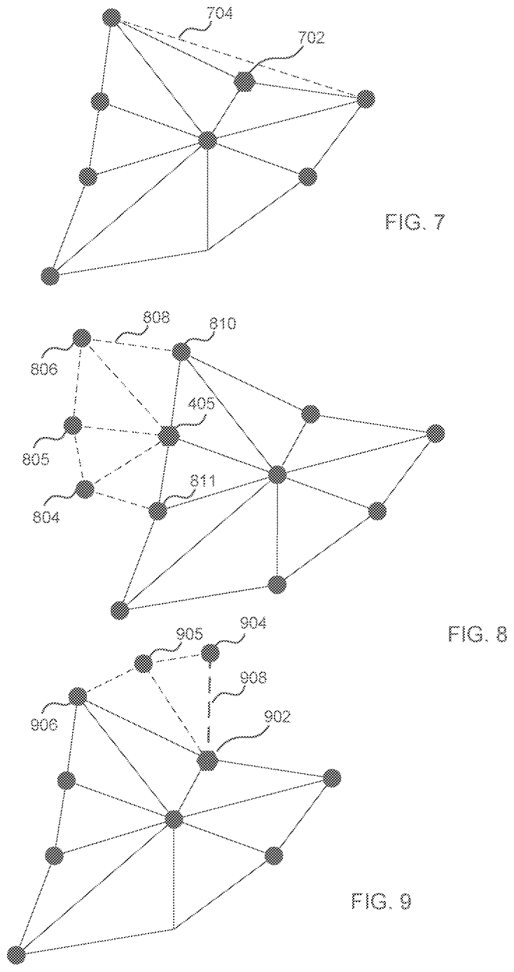

FIG. 8 shows a glue vertex 405 (as indicated by a solid hexagon) which is of the second type in the table above (I1+), i.e. an ‘interior glue vertex with one or more new connected vertices’ (V:=V+v, where v is the number of new connected vertices). In this example, there are three new connected vertices 804-806 (e.g. v=3). If the glue vertex has this type, then it implicitly specifies a plurality of new edges 808 (indicated by the dashed lines) which connect each new vertex 804-806 to the glue vertex as well as connecting the new vertices together and connecting the new vertices to the existing vertices 810-811 either side of the glue vertex. The number of new edges is equal to twice the number of new vertices, plus one (E:=E+2v+1). The number of primitives that are encoded is also increased and by the number of new vertices plus one (F:=F+v+1) and the number of boundary vertices is increased by one less than the number of new vertices since the glue vertex is no longer a boundary vertex (B:=B+v−1).

FIG. 9 shows a glue vertex 902 (as indicated by a solid hexagon) which is of the third type in the table above (L1+), i.e. a ‘boundary glue vertex with one or more new connected vertices added on the left’ (V:=V+v, where v is the number of new connected vertices). In this example, there are two new connected vertices 904-905 (e.g. v=2). If the glue vertex has this type, then it implicitly specifies a plurality of new edges (indicated by the dashed lines) which connect each new vertex 904-905 to the glue vertex as well as connecting the new vertices together and connecting one of the new vertices to the existing vertex 906 to the left of the glue vertex. The number of new edges is equal to twice the number of new vertices (E:=E+2v). The number of primitives that have been encoded is also increased by the number of new vertices (F:=F+v) and the number of boundary vertices is increased by the number of new vertices since the glue vertex remains a boundary vertex (B:=B+v). Where the glue vertex is of this type, one of the newly formed edges 908 must be on the final boundary of the meshlet.

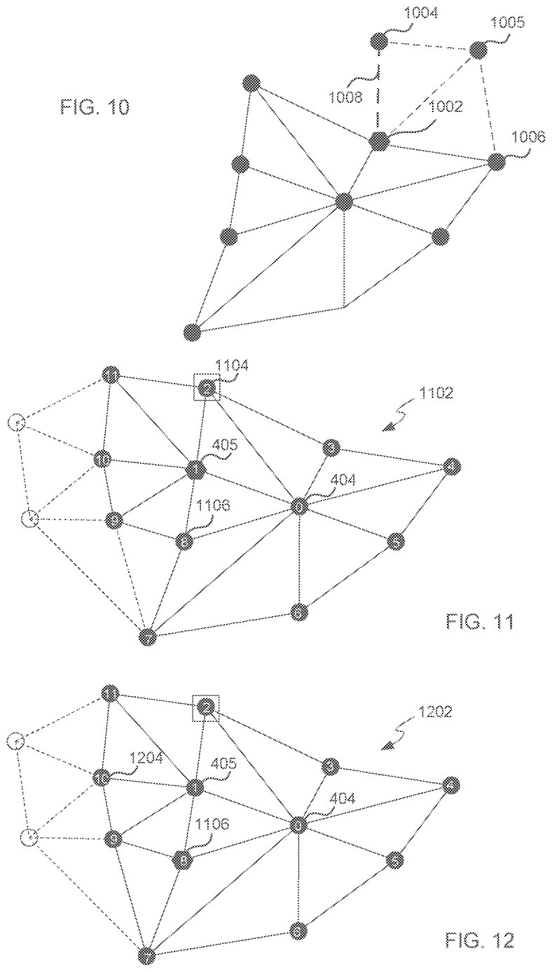

FIG. 10 shows a glue vertex 1002 (as indicated by a solid hexagon) which is of the fourth type in the table above (R1+), i.e. a ‘boundary glue vertex with one or more new connected vertices added on the right’ (V:=V+v, where v is the number of new connected vertices). In this example, there are two new connected vertices 1004-1005 (e.g. v=2). If the glue vertex has this type, then it implicitly specifies a plurality of new edges (indicated by the dashed lines) which connect each new vertex 1004-1005 to the glue vertex as well as connecting the new vertices together and connecting one of the new vertices to the existing vertex 1006 to the right of the glue vertex. The number of new edges is equal to twice the number of new vertices (E:=E+2v). The number of primitives that have been encoded is also increased by the number of new vertices (F:=F+v) and the number of boundary vertices is increased by the number of new vertices since the glue vertex remains a boundary vertex (B:=B+v). Where the glue vertex is of this type, one of the newly formed edges 1008 must be on the final boundary of the meshlet.

As shown in FIG. 8, where the glue vertex is an ‘interior glue vertex with one or more new connected vertices’, the new primitives that are encoded comprise a full or closed fan of primitives, i.e. the primitives fill the entire angle that is exterior to the glue vertex. Where, as described above, a fan of primitives is a strip of primitives with a common vertex (the glue vertex). In contrast where the glue vertex is a ‘boundary glue vertex with one or more new connected vertices added on the left’ or a ‘boundary glue vertex with one or more new connected vertices added on the right’, the new primitives that are encoded comprise an open fan of primitives, i.e. the primitives do not fill the entire angle that is exterior to the glue vertex. A single vertex may have more than one glue operation, where for one glue operation the glue vertex is a ‘boundary glue vertex with one or more new connected vertices added on the left’ and for another glue operation the glue vertex is a ‘boundary glue vertex with one or more new connected vertices added on the right’.

Referring back to the example shown in FIG. 6, where the initial encoding (from block 304) was 00101, the glue vertex that is selected may be vertex 405 (as shown in FIG. 8) which has a glue type of ‘interior glue vertex with one or more new connected vertices’ (I1+), where there are 3 new connected vertices (v=3). The following bit sequence is therefore appended to the original encoding (in block 308): 001010, portioned as 0|01|010. This comprises bits 01 which are data identifying the glue type of the glue vertex (portion 512) and bits 010 data indicating the number of new connected vertices (portion 514). The length of the bit string that indicates the number of new connected vertices (portion 514) is determined by the maximum possible number of new vertices and the number of vertices already encoded in the encoding. The maximum possible number of new vertices is given by the pre-defined maximum number of vertices per meshlet, Vₘₐₓ, minus the number of vertices prior to the addition of these new vertices, i.e. the value of V prior to addition of these new vertices. In this example, V=9, and Vₘₐₓ=14, so the number of new connected vertices, v, is between 1 (vₘᵢₙ) and 5 (vₘₐₓ). This requires 3 bits. As in the initial encoding, the data indicating the number of new connected vertices may be a relative value (with the minimum number, vₘᵢₙ, being 1 given the glue type and hence the value encoded is 3−1=2) or the absolute value of v (3 in this example meshlet) may be encoded. The first bit that is appended to the encoding, 0 in this example, is included in place of data identifying the glue vertex, to indicate that the decompression process does not terminate at this step, before all Vₘₐₓ vertices have been connected. As described above, where the starting vertex is an ‘interior initial vertex with three or more connected vertices’, any boundary vertex may be selected as the glue vertex and so the data identifying the glue vertex only requires one state and, for this second part of the encoding 508, the first portion may comprise a single bit only indicating whether the glue vertex is the last glue vertex or whether there is a subsequent glue operation, for example if the variation supports up to and including Vₘₐₓ vertices (e.g. Vₘₐₓ=14). In the example shown, a 0 indicates that there is a subsequent glue operation (as there is only one possible glue vertex index in this instance) and a 1 indicates that there is no further glue operation. Where the variation supports exactly Vₘₐₓ vertices (e.g. Vₘₐₓ=14) this bit may be omitted.

For the meshlet shown in FIG. 4, after two glue operations (an initial one and one subsequent one), the encoding of the partial meshlet 1102 is 00101001010 and the encoded parts of the meshlet are shown by the solid circles and lines in FIG. 11 (with the starting vertex 404 and first glue vertex 405). At this point, V=12, E=23, F=12 and B=10.

The method of FIG. 3 then continues by determining whether the entire meshlet is encoded (block 310). The entire meshlet is not yet encoded (‘No’ in block 310) and so the method proceeds to select a next glue vertex in the meshlet (block 306). The glue vertex is selected from vertices that have already been described in the encoding (e.g. those vertices which are shown in FIG. 8) according to the pre-defined set of rules, i.e. according to the same pre-defined set of rules that would have been used to select the first glue vertex after the starting vertex in the situation where the starting vertex is a ‘boundary initial vertex with two or more connected vertices’. The same pre-defined set of rules are used to select a glue vertex throughout the compression method of FIG. 3 and the corresponding decompression method described below.

The table below sets out an example pre-defined set of precedence rules with the rules being ordered from most important to least important. Two alternatives are provided for rule 4, labelled option A and option B. In any implementation, one of these options only will be used.

| | |
|---|---|
| 1 | Interior glue vertex with no new connected vertices (I0) |
| 2 | The vertex of any one of the following types with the |
| | highest number of added vertices (i.e. largest value of v): |
| | Interior glue vertex with one or more new connected |
| | vertices (I1+) |
| | Boundary glue vertex with one or more new connected |
| | vertices added on the left (L1+) |
| | Boundary glue vertex with one or more new connected |
| | vertices added on the right (R1+) |
| 3 | Where they have the same number of added vertices, |
| | ‘interior glue vertex with one or more new |
| | connected vertices' (I1+) has higher precedence |
| | than either ‘boundary glue vertex with one or more |
| | new connected vertices added on the left’ (L1+) |
| | or ‘boundary glue vertex with one or more new |
| | connected vertices added on the right’ (R1+) |
| 4 - | Otherwise, as a tie-break, there is a clockwise ordering |
| option A | of vertices starting from a cycle start point vertex |
| 4 - | Otherwise, as a tie-break, by meshlet vertex index |
| option B | |
| 5 | For an individual vertex, a ‘boundary glue vertex |
| | with one or more new connected vertices added on the |
| | left’ has higher precedence than ‘a boundary |
| | glue vertex with one or more new connected vertices |
| | added on the right’ |

The cycle start point vertex referred to in rule 4, option A above may initially be the starting vertex (as selected in block 302) if that vertex is a ‘boundary initial vertex with two or more connected vertices’ (B2+). However, if this vertex has is an ‘interior initial vertex with three or more connected vertices’, then this vertex will no longer be on the boundary after the new vertices are added and in this case, and as a cycle may not be defined until after this first glue operation, may be chosen (in block 303) from one of the newly added vertices on the boundary based on a pre-defined rule (e.g. it may be vertex with index 1). Later in the glue operations, if the cycle start point vertex becomes an interior vertex after a glue operation, a new cycle start point vertex is chosen based on a pre-defined rule. Any well-defined deterministic rule may be used as long as the same rule is used in both the compression and decompression methods. In an example, the cycle start point vertex moves to the next vertex in the previous boundary in a clockwise direction. As the newly added vertices will have the largest indices, by using this rule, the spatial coherency is maximised.

Rule 1 gives a glue vertex that is an ‘interior glue vertex with no new connected vertices’ highest precedence because this particular glue operation can block other glue operations from occurring if not done first. This is demonstrated in FIGS. 11 and 12, as described below, where, without this rule and hence no addition of the primitive glued to vertex 8 (and where the other vertices in the primitive are vertices 7 and 9), the gluing of new primitives to vertex 9 would be prevented.

Rule 2 above aims to encode the meshlet by encoding as many vertices as possible as early as possible in the compression method of FIG. 3. This order of precedence has the effect of limiting the possible options in later iterations of the method (i.e. in later loops of blocks 306-310) and therefore can be used to reduce the length of the encoding. For example, by adding vertices earlier, it reduces the maximum number of vertices that can be added in a later iteration and hence reduces the number of bits required to encode data indicating the number of new connected vertices (where this number of bits must be capable of encoding all possible values of v at this stage), i.e. it reduces the possible values of v, where the minimum value of v, vₘᵢₙ, is determined by the glue type and the maximum value of v, Vₘₐₓ=Vₘₐₓ−V.

Rule 3 gives higher precedence to interior glue vertices, compared to boundary glue vertices, as these will compress a bigger amount of the meshlet per operation than boundary glue vertices.

Rules 4-5 are an arbitrary selection; however, as described above, by specifying this selection in pre-defined rules, it reduces the data required within the encoding (e.g. data specifying a selection is not required to be included within the encoding).

Two different options are provided for rule 4 in the table above; however in any implementation the same option is always used. Using option B (tie-break by meshlet vertex index) reduces the overhead of storing the current boundary vertices (with one or more glue types available), as it only requires an unordered set of vertices rather than an ordered one. In this case, the storage of the current boundary vertices could be indicated as a bit field (with no cycle start point), rather than a list of indices (with the first entry referring to the cycle start point vertex). However, using option B may be less spatially coherent than option A (because the ordering in option B is based on vertex index rather than the ordered list of option A, where the ordered list is related to the spatial arrangement of vertices, e.g. as described with reference to the table below).

In the example shown in FIG. 11, the previous glue vertex 405 (with vertex index 1), and also the previous cycle start point vertex, is now an interior vertex and so the cycle start point is moved clockwise along the previous boundary to vertex 1104 (with vertex index 2). The cycle start point is indicated in FIG. 11 using a square around the vertex. According to the pre-defined rules above, the next glue vertex is selected to be vertex 1106 (with vertex index 8) according to rule 1 since this vertex has a glue type of ‘interior glue vertex with no new connected vertices’ (I0).

Having selected a next glue vertex (in block 306), a next part 516 of the encoding 500 is appended in block 308 to the partial encoding that has already been created (in block 304 and the previous iteration of block 308). As in the previous iteration, this next part 516 comprises one or more of the following: data identifying the glue vertex (portion 510), data identifying the glue type of the glue vertex (portion 512) and data indicating the number of new connected vertices (portion 514). The last of these (i.e. the data indicating the number of new connected vertices) is only included for glue types where there are new connected vertices and so can be omitted if the glue vertex is an ‘interior glue vertex with no new connected vertices’ (I0).

For the example shown in FIG. 11, the selected glue vertex 1106 (vertex index 8) is an ‘interior glue vertex with no new connected vertices’ (I0) and so the bits that are appended (in block 308) are 011000, portioned as 0110|00. The first four bits, 0110, identify the glue vertex. There are 11 possible options: one of vertices 2-11 or early termination (i.e. there is no next glue vertex) and again in this example, a relative index is used. As vertices 0 and 1 are not boundary vertices, the mapping between relative index and vertex index is as shown below:

| Relative | Vertex |
|---|---|
| index | index |
| 0 | 2 |
| 1 | 3 |
| 2 | 4 |
| 3 | 5 |
| 4 | 6 |
| 5 | 7 |
| 6 | 8 |
| 7 | 9 |
| 8 | 10 |
| 9 | 11 |
| 10 | No next glue vertex |
| | (also referred to as |
| | ‘early termination’) |

The order of vertex indices in the righthand column of the table above is determined by the order of the vertices on the meshlet boundary in a pre-defined direction (e.g. clockwise) starting at the cycle start point vertex. This means that whilst in this example, the vertex indices are listed in a contiguous run, in other examples the vertices may be listed out of numerical order by vertex index. A list of the vertices on the meshlet boundary in the pre-defined direction is stored in order to be able to use relative indices in this way. Referring to the mapping in the table, in this example relative index is 6, which is 0110 in binary. As described above, in other implementations, the actual index (e.g. 8) may instead be encoded but this may, in some implementations, result in longer code lengths. This is because as you get closer to the end of the compression, there will be fewer options for the next glue vertex (leading to a shorter relative index). The last two bits, 00, identify the glue type and as no vertices are added (I0), there is no data indicating the number of new connected vertices.

For the meshlet shown in FIG. 4, after three glue operations (an initial one and two subsequent ones), the encoding of the partial meshlet 1202 is 00101001010011000 and the encoded parts of the meshlet are shown by the solid circles and lines in FIG. 12 (with the starting vertex 404, first glue vertex 405 and second glue vertex 1106). At this point, V=12, E=24, F=15 and B=9.

The method repeats until the entire meshlet is encoded (‘Yes’ in block 310). At this point, a termination sequence 518 may be appended to the encoding (block 314) and the resultant encoding, as generated for the entire meshlet using the method of FIG. 3, is then stored and/or output (block 316). Alternatively, a termination sequence 518 may only be added where pre-defined termination criteria are not met (‘No’ in block 312). In a first example, the termination criteria are not met (and hence a termination sequence 518 may be required) if no further vertices need to be connected for the meshlet but the maximum number of vertices, Vₘₐₓ, has not been reached (i.e. some current boundary vertex has I1+, L1+ or R1+ glue types available), or the maximum number of vertices, Vₘₐₓ, has been reached and no further I0 glue type operations are required but some current boundary vertex has the I0 glue type available (‘No’ in block 312). The termination criteria are met (and hence a termination sequence may be omitted) if no current boundary vertex has any glue types available, possibly due to the maximum number of vertices being reached (‘Yes’ in block 312). In a second example, the termination criteria does not depend upon whether the maximum number of vertices has been reached but instead on the availability of the I0 glue type. In this example, the termination criteria are not met (and hence a termination sequence 518 may be required) if no further I0 glue type operations are required but some current boundary vertex has the I0 glue type available (‘No’ in block 312). The termination criteria are met (and hence a termination sequence may be omitted) if no current boundary vertex has any I0 glue type available (‘Yes’ in block 312). Where a termination sequence is used, it may be equal to the current number of boundary vertices having at least one appropriate glue type available, i.e. one more than the maximum index for a glue vertex (e.g. it corresponds to the ‘no next glue vertex’ relative index in the table above). The use of a termination sequence in this way may require an extra bit for the glue vertex encoding (e.g. if it increases the number of glue vertex options from a set of size 2ⁿ (represented by n bits) to a set of size 2ⁿ+1 (represented by n+1 bits). The resultant encoding, as generated for the entire meshlet using the method of FIG. 3, is then stored and/or output (block 316).

In order to fully encode the meshlet 402 shown in FIG. 4, two additional iterations of the method of FIG. 3 are required. The next glue vertex that is selected according to the pre-defined rules described above (in block 306) is vertex 1204 (vertex index 10) as shown in FIG. 12. This is the vertex with the highest number of added vertices, v=2 (rule 2).

For the example shown in FIG. 12, the selected glue vertex 1204 (vertex index 10) is an ‘interior glue vertex with one or more new connected vertices’ (I1+) and so the bits that are appended (in block 308) are 0111011, portioned as 0111|01|1. The first four bits, 0111, identify the glue vertex using a relative index, i.e. a value relative to the position of the glue vertex within the current boundary, starting from the cycle start point vertex. The bits represent the value 7 in binary which, when indexed from 0, means that the glue vertex is the 8th boundary vertex, starting at the cycle start point vertex. Given that the boundary vertices have indices 2, 3, 4, 5, 6, 7, 9, 10 and 11 (in order), this means that the glue vertex has index 10. The next two bits, 01, identify the glue type (I1+) and the final bit, 1, indicates that the number of new connected vertices is 2 (again where the relative value, v−vₘᵢₙ, is the binary number encoded in this example, and vₘᵢₙ for this glue type is 1).

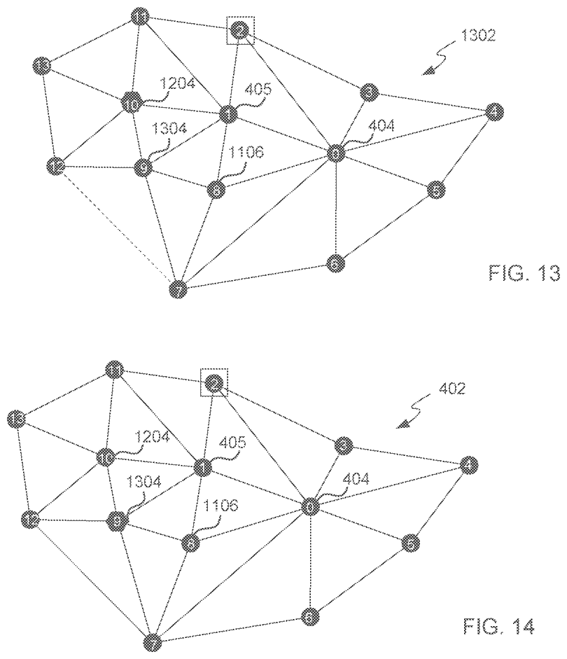

For the meshlet shown in FIG. 4, after four glue operations (an initial one and three subsequent ones), the encoding of the partial meshlet 1302 is 001010010100110000111011 and the encoded parts of the meshlet are shown by the solid circles and lines in FIG. 13 (with the starting vertex 404, first glue vertex 405, second glue vertex 1106 and third glue vertex 1204). At this point, V=14, E=29, F=16 and B=10.

The next glue vertex that is selected according to the pre-defined rules described above (in block 306) is vertex 1304 (vertex index 9) as shown in FIG. 13. This is an ‘interior glue vertex with no new connected vertices’ (i.e. I0). This is the only possible glue type since V=Vₘₐₓ. The bits that are appended (in block 308) are 001. The three bits, 001, identify the glue vertex. The bits represent the value 1 in binary which, when indexed from 0, means that the glue vertex is the 2^{nd} boundary vertex, starting at the cycle start point vertex. Prior to this step, the vertices considered have been all the vertices on the current meshlet boundary; however, given that V=Vₘₐₓ the only possible glue type is I0. Due to the order of precedence rules (as above) and given that the vertex with index 8 was previously selected as being the glue vertex (as described above with reference to FIG. 11), then vertices 2, 3, 4, 5 and 6 cannot have glue type I0. This means that the boundary vertices which could have glue type I0 have indices 7, 9, 12, 13, and 11 (in order). This is why bits 001 indicate the glue vertex has index 9. There are no bits to identify the glue type because V=Vₘₐₓ and so the only possible glue type is an ‘interior glue vertex with no new connected vertices’ (i.e. I0) and as a consequence of the glue type there are no new connected vertices and so no bits to encode the number of new connected vertices.

For the meshlet shown in FIG. 4, after five glue operations (an initial one with starting vertex 405 and four subsequent ones with glue vertices 405, 1106, 1204, 1304), the entire meshlet is encoded. At this point, V=14, E=30, F=17 and B=9. As there are still four outstanding vertices on the boundary of the meshlet which could have glue type I0 (vertices with indices 7, 12, 13 and 11), a termination sequence, e.g. 100, is added (in block 314) to produce an encoding of 001010010100110000111011001100 which may be output and/or stored (in block 316).

As described above, the compression method described herein and shown in FIG. 3 starts by selecting a starting vertex within the meshlet (in block 302) and, if the starting vertex is an interior vertex, selecting an initial cycle start point vertex (in block 303). The compression method then proceeds by iteratively adding sequences of bits to the encoding (in blocks 304 and 308 and optionally block 314)) until the encoding describes the entire meshlet. The starting vertex may be selected (in block 302) at random or selected based on pre-defined selection criteria or rules.

Where the starting vertex is selected (in block 302) based on pre-defined selection criteria or rules, these may comprise one or more of the following: (a) the vertex with the highest valence (i.e. the vertex with the largest number of edges connected to it), (b) the vertex with largest number of primitives connected to it, (c) the vertex which is “farthest” from the boundary (e.g. the vertex with the most edges/primitives in its shortest path to the boundary of the meshlet), (d) an arbitrary interior vertex rather than an arbitrary boundary vertex. These same pre-defined selection criteria or rules may also be used to select the initial start point vertex (in block 303) where required.

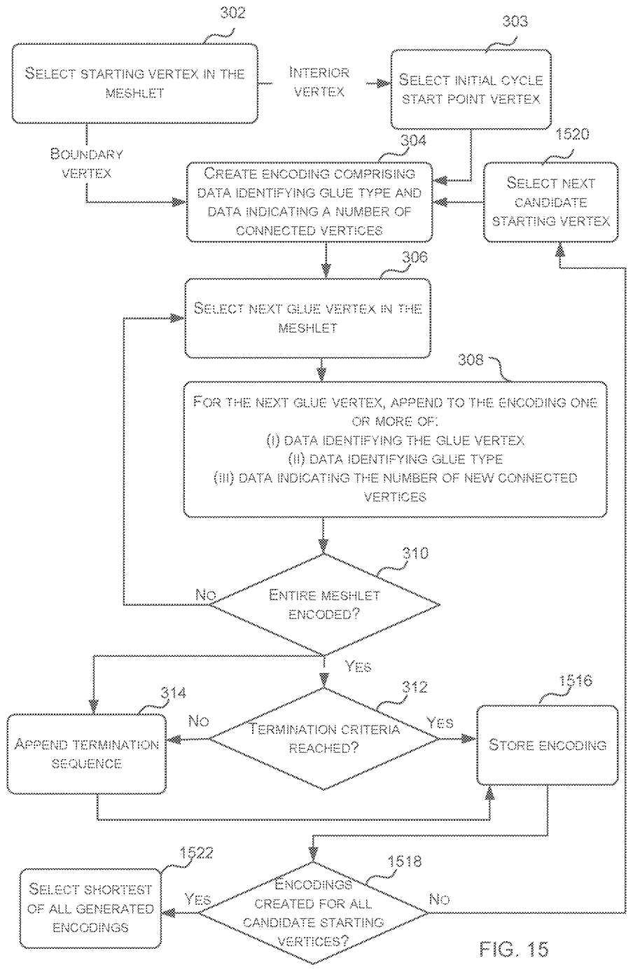

FIG. 15 shows a variation of the method of FIG. 3 in which the method of FIG. 3 is performed for a number of different starting vertices and the encodings that are generated are then compared and the shortest one is selected and output. As shown in FIG. 15, the method initially proceeds as in FIG. 3; however, having generated the encoding (and stored it in block 1516), it is determined whether there are other vertices that should be considered as possible starting vertices (block 1518). These possible starting vertices are referred to herein as candidate starting vertices. If encodings for the entire meshlet have not yet been generated starting from each of the candidate starting vertices (‘No’ in block 1518), the method is repeated until an encoding for the meshlet has been generated for each of the candidate starting vertices. Once all the encodings have been generated (‘Yes’ in block 1518), then the shortest encoding of all those have been generated is selected as the encoding for the meshlet (block 1522) and output or stored. Where there are more than one encodings that have the same shortest length of all those that have been generated, a tiebreak criteria may be used to select one of the encodings having the shortest length, or one may be selected arbitrarily, e.g., on a first-come basis, or based on the number of 1s and/or fewest bit flips (i.e. changes from a zero to a one or a one to a zero between adjacent bits) as this may provide a small power saving.

The candidate starting vertices which are considered in the method of FIG. 15 may comprise all the vertices in the meshlet or only a subset of the vertices in the meshlet. Where the candidate starting vertices are only a subset of the vertices in the meshlet, the candidate starting vertices may be selected based on pre-defined selection criteria or rules, e.g. only the interior vertices. In the method of FIG. 15, the initial starting vertex that is selected (in block 302) may be selected at random from the set of candidate starting vertices.

By using the method of FIG. 15, the amount of compression of the meshlet topology is increased by the selection of the shortest encoding of all those generated (in block 1522). This method is feasible because the multiple iterations of the method to generate the multiple encodings, one each for a plurality of candidate starting vertices, can be performed offline (otherwise it might introduce delays if processed serially, or a larger area of hardware if processed in parallel). In contrast, the use of pre-defined selection criteria or rules to select only a single starting vertex (as in the method of FIG. 3) requires less processing power to perform the compression but may result in less compression (e.g. where the selected starting vertex results in an encoding that is longer than a different starting vertex that would have been considered had the method of FIG. 15 been used).

A second example implementation of the method of FIG. 3 can be described with reference to FIGS. 16-20. In this example, the meshlet is the same as in the previous example (i.e. the meshlet in FIG. 4); however, in this example, the starting vertex that is selected (in block 302) is a boundary vertex 408. This vertex has a glue type of a ‘boundary initial vertex with two or more connected vertices’, with v=5. The initial encoding (as created in block 304) is therefore: 10011, portioned as 1|0011, with the first bit encoding the glue type (i.e. B2+) and the remaining bits encoding the number of connected vertices (5−2=3). Four bits are used to encode the number of connected vertices because there are 12 possible options (we can add from 2 up to 13 new vertices). At this point in the method, the portion 1602 of the meshlet that is encoded by the initial encoding comprises V=v+1=6, E=2v−1=9, F=v−1=4 and B=v+1=6.

Considering the pre-defined rules for selection of the next glue vertex (in block 306), there are no vertices that are already encoded that satisfy rule 1. Considering rule 2, the possible vertices for selection are:

| Vertex | | Number of |
|---|---|---|
| index | Glue type | vertices added |
| 1 | Boundary glue vertex with one or more new | 2 |
| | connected vertices added on the right | |
| 2 | Interior glue vertex with one or more new | 2 |
| | connected vertices | |
| 3 | Interior glue vertex with one or more new | 1 |
| | connected vertices | |
| 4 | Interior glue vertex with one or more new | 5 |
| | connected vertices | |
| 5 | Boundary glue vertex with one or more new | 1 |
| | connected vertices added on the left | |

Based on rule 2, vertex 4 is selected as the next glue vertex (in block 306). The bits that are appended to the initial encoding (in block 308) are therefore: 001101100, portioned as 011|01|100, with the first three bits identifying the glue vertex as there are 6 glue index options, vertices with indices 1-5 or early termination (vertex 4 is 4th of these options, 4−1=3, 011), the next two bits (01) encoding the glue type (i.e. I1+) and the remaining three bits encoding the number of connected vertices since there are 8 possible options (5−1=4, 100). At this point in the method, the encoding is 1001101101100 and the portion 1702 of the meshlet that is encoded, as shown by the solid circles and lines in FIG. 17, comprises V:=V+v=6+5=11, E:=E+2v+1=9+10+1=20, F:=F+v+1=4+5+1=10 and B:=B+v−1=6+5−1=10.

Considering the pre-defined rules for selection of the next glue vertex (in block 306), vertex 3 now satisfies rule 1. The bits that are appended to the initial encoding (in block 308) are therefore: 001000, portioned as 0010|00, with the first four bits identifying the glue vertex (3−1=2, 0010) and the next two bits (00) encoding the glue type (i.e. I0). At this point in the method, the encoding is 1001101101100001000 and the portion 1802 of the meshlet that is encoded, as shown by the solid circles and lines in FIG. 18, comprises V:=V=11, E:=E+1=20+1=21, F:=F+1=10+1=11 and B:=B−1=10−1=9.

Considering the pre-defined rules for selection of the next glue vertex (in block 306), there are no vertices that are already encoded that satisfy rule 1. Considering rule 2, the possible vertices for selection are:

| Vertex | | Number of |
|---|---|---|
| index | Glue type | vertices added |
| 1 | Boundary glue vertex with one or more new | 2 |
| | connected vertices added on the right | |
| 2 | Interior glue vertex with one or more new | 1 |
| | connected vertices | |
| 6 | Interior glue vertex with one or more new | 2 |
| | connected vertices | |
| 7 | Boundary glue vertex with one or more new | 1 |
| | connected vertices added on the left | |

Boundary vertices with indices 8, 9, 10 and 5 are excluded from the table above because they have no more vertices to connect and so they cannot be selected as the next glue vertex using the rules described above. However, these four vertices are considered when determining the number of options for encoding the glue vertex, as described below.

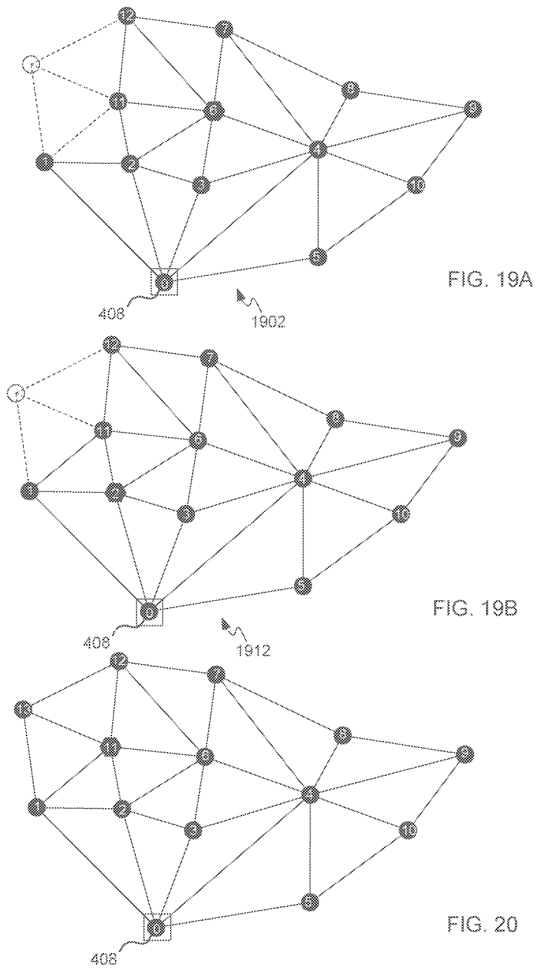

Based on rule 2, there are two possible vertices that could be selected (vertices 1 and 6); however, using rule 3 vertex 6 is selected as the next glue vertex (in block 306). The bits that are appended to the initial encoding (in block 308) are therefore: 00100101, portioned as 0010|01|01, with the first four bits identifying the glue vertex (there are 9 options: 1, 2, 6, 7, 8, 9, 10, 5 and early termination, vertex 6 is the third of these options, 3−1=2, 0010), the next two bits (01) encoding the glue type (i.e. I1+) and the remaining bits encoding the number of connected vertices (2−1=1, 01). Here only two bits are used to encode the number of remaining vertices because V=11 and Vₘₐₓ=14, so the maximum number of vertices that could be added is three. At this point in the method, the encoding is 100110110110000100000100101 and the portion 1902 of the meshlet that is encoded, as shown by the solid circles and lines in FIG. 19A, comprises V:=V+v=11+2=13, E:=E+2v+1=21+4+1=26, F:=F+v+1=11+2+1=14 and B:=B+v−1=9+2−1=10.

Considering the pre-defined rules for selection of the next glue vertex (in block 306), vertex 2 satisfies rule 1. The bits that are appended to the initial encoding (in block 308) are therefore: 000100, portioned as 0001|00, with the first four bits identifying the glue vertex (there are 10 options: 1, 2, 11, 12, 7, 8, 9, 10, 5 and early termination, vertex 2 is the second of these options, 2−1=1, 0001) and the last two bits (00) encoding the glue type. Given the glue type (‘interior glue vertex with no new connected vertices’, I0) the appended bits do not need to include any bits to indicate the number of connected vertices. At this point in the method, the encoding is 100110110110000100000100101000100 and the portion 1912 of the meshlet that is encoded, as shown by the solid circles and lines in FIG. 19B, comprises V:=V=13, E:=E+1=26+1=27, F:=F+1=14+1=15 and B:=B−1=10−1=9.

Considering the pre-defined rules for selection of the next glue vertex (in block 306), there are no vertices that are already encoded that satisfy rule 1. Considering rule 2, the possible vertices for selection are:

| Vertex | | Number of |
|---|---|---|
| index | Glue type | vertices added |
| 11 | Interior glue vertex with one or more new | 1 |
| | connected vertices | |
| 12 | Boundary glue vertex with one or more new | 1 |
| | connected vertices added on the left | |

Based on rule 3, vertex 11 is selected as the next glue vertex (in block 306). The bits that are appended to the initial encoding (in block 308) are therefore: 000101, portioned as 0001|01, with the first four bits identifying the glue vertex (0001), the next two bits (01) encoding the glue type (i.e. I1+). It is not necessary to include bits identifying the number of connected vertices because V=13 and Vₘₐₓ=14, so the maximum number of vertices that could be added is one. At this point in the method, the encoding is 100110110110000100000100101000100000101 and the entire meshlet is encoded, as shown by the solid circles and lines in FIG. 20, comprises V:=V+v=13+1=14, E:=E+2v+1=27+2+1=30, F:=F+v+1=15+1+1=17 and B:=B+v−1=9+1−1=9.

At this point, a termination sequence 518 may be appended to the encoding (block 314) and the resultant encoding, as generated for the entire meshlet using the method of FIG. 3, is then stored and/or output (block 316). In a variation, however, a termination sequence 518 may only be appended if the termination criteria (as described above) have not been met (‘No’ in block 312). In the example shown in FIG. 20, however, there are a number of boundary vertices which still have the I0 glue type available (vertices 1, 13 and 12). The I0 glue type has been eliminated for the other boundary vertices (vertices 7, 8, 9 and 10) due to the order of precedence rule in the previous step. The termination sequence 518 therefore encodes the selection from the four options: 1, 13, 12 and early termination and hence requires two bits (11). The resultant encoding, as generated for the entire meshlet using the method of FIG. 3, is then stored and/or output (block 316).

The encodings obtained for the meshlet 402 shown in FIG. 4 and the two different starting vertices 404, 408 are shown in the table below. It can be seen from the table that by starting with vertex 404, the encoding is considerably shorter (30 bits compared to 41 bits). Consequently, if the method of FIG. 15 was used and these were the two candidate starting vertices, the first of these encodings would be selected (in block 1522).

| Starting | |
|---|---|
| vertex | Encoding |
| 404 | 001010010100110000111011001100 |
| 408 | 10011011011000010000010010100010000010111 |

FIG. 21 is a flow diagram of a first example of the method of lossless decompression of meshlet topology data and this decompression method is the inverse of the compression method described above with reference to FIG. 3. Like FIG. 3, the method of FIG. 21 encompasses two variations, dependent upon whether termination sequences are used or not in the compression method.

To perform decompression, a first sequence of bits is read from an encoding (block 2102). The encoding is a string of bits that may have been generated using the method of FIG. 3 or 15 and two example encodings are shown in the table above. The first sequence of bits that is read (in block 2102) comprises a pre-defined number of bits and in an example, the first sequence comprises 5 bits. This first sequence comprises one or more bits that indicate a glue type of a starting vertex in the meshlet and one or more bits that indicate a number of vertices that are connected to this starting vertex. As described above in relation to the compression method, the bits that indicate the number of vertices that are connected may be a binary representation of the absolute number or a relative number. Where a relative number is used, this may be dependent upon the glue type, as also described above. Having read the first sequence (in block 2102), the glue type of the starting vertex and number of connected vertices are determined (block 2104) and the topology of an initial portion of the meshlet is constructed (block 2106). This construction (in block 2106) comprises adding the identified number of vertices to the starting vertex according to the identified glue type and storing intermediate data about the constructed portion of the meshlet including data specific to each of the boundary vertices (i.e. vertices which are on the boundary of the portion of the meshlet that has been constructed at this point in the method).

The intermediate data that is stored (in block 2106) comprises at least two of the values of four parameters: the number of vertices, V, in the portion of the meshlet that has been constructed, the number of edges, E, in the portion of the meshlet, the number of primitives, F, in the portion of the meshlet and the number of vertices on the boundary of the portion of the meshlet, B. As described above, where one or two of V, E, F and B are not stored, their values may be derived as described above, Additionally, the indices of the boundary vertices and their order (starting at the cycle start point vertex) is stored along with, for each boundary vertex, information on the available glue types and the maximum number of vertices available per glue type (for that boundary vertex). This information for a boundary vertex may be stored as: the minimum and maximum number of interior vertices, I, that could be connected to that vertex, the minimum and maximum number of vertices on its left boundary, L, that could be connected to that vertex and the minimum and maximum number of vertices on its right boundary, R, that could be connected to that vertex. In other examples, the information may be stored in a different way, such as a bit indicating whether the glue type I0 is available or not and, for each of the glue types I1+, L1+ and R1+: a maximum number of vertices for the particular glue type (there is an implicit minimum of one vertex as a consequence of the glue type), plus an invalid state for the maximum or a separate bit to indicate when the particular glue type is not available (i.e. not possible). This latter representation is slightly more compact than storing values of minimum and maximum values of I, L and R for each boundary vertex.

In examples where minimum and maximum values of I, L and R are stored for each boundary vertex, these values map to available glue types as shown in the table below, although as shown in later examples, a more compact format may be used which relies on the fact that Iₘᵢₙ can only be zero or one and Lₘᵢₙ and Rₘᵢₙ are always one.

| | |
|---|---|
| Iₘₐₓ ≥ Iₘᵢₙ and Iₘᵢₙ = 0 | I0 available |
| Iₘₐₓ ≥ max(Iₘᵢₙ, 1) and Iₘᵢₙ ≥ 0 | I1+ available |
| Lₘₐₓ ≥ max(Lₘᵢₙ, 1) and Lₘᵢₙ ≥ 1 | L1+ available |
| Rₘₐₓ ≥ max(Rₘᵢₙ, 1) and Rₘᵢₙ ≥ 1 | R1+ available |

The values of V, E, F, B that are to be stored in the intermediate data (in block 2106) are determined based on the glue type and the identified number of connected vertices, v. They are set out in the table below with the updates to the V, E, F, B data for the meshlet shown on in the left column and the updates to the I, L, R data for each boundary vertex shown in the right column. In the table below it is assumed that the updates in the left-hand box occur before those in the righthand box in the same row (i.e. so the value of V that is subtracted is the updated value of V, rather than the value of V before it is updated as shown in the box in the left-hand column of the same row of the table). As noted above, the I, L, R data for a boundary vertex is just one example way of storing information on the available glue types for the boundary vertex and the maximum number of vertices available per glue type for that boundary vertex.

Interior initial vertex with three or more connected vertices

| | |
|---|---|
| V = v + 1 | For newly added vertices: |
| E = 2v | Iₘᵢₙ = 0 |
| F = v | Lₘᵢₙ = 1 |
| B = v | Rₘᵢₙ = 1 |
| | Iₘₐₓ = Lₘₐₓ = Rₘₐₓ = Vₘₐₓ − V |

Boundary initial vertex with two or more connected vertices

| | |
|---|---|
| V = v + 1 | For newly added vertices not known to be on the final boundary: |
| E = 2v − 1 | Iₘᵢₙ = 0 |
| F = v − 1 | Lₘᵢₙ = 1 |
| B = v + 1 | Rₘᵢₙ = 1 |
| | Iₘₐₓ = Lₘₐₓ = Rₘₐₓ = Vₘₐₓ − V |
| | For the starting vertex: |
| | Delete all I, L, R data, or set invalid states, or otherwise indicate that there are no |
| | remaining possible glue type options for this vertex. For example, where Vₘₐₓ = 14, |
| | the bit sequence 1111 (binary for 15) may be used as a code to set an invalid state. |
| | For the two vertices either side of the starting vertex (which are known to be on the |
| | final boundary): |
| | Delete all I data, or set an invalid state, to indicate that the interior glue type option is |
| | no longer available. |
| | Delete one of the L and R data, or set a corresponding invalid state, dependent |
| | upon which side the implicitly known boundary edge is, to indicate that one of the left |
| | and right boundary glue type options is no longer available. |
| | For the surviving glue type (which is the other of L and R), set the minimum number |
| | of vertices to 1 and the maximum number to the remaining number of vertices (Vₘₐₓ − |
| | V) |

The method then proceeds to read a next sequence of bits from the encoding (block 2108). The reading of the next sequence of bits (in block 2108) is done portion by portion. As described above there may be up to three portions, where these portions are: data identifying the glue vertex (portion 510), data identifying the glue type of the glue vertex (portion 512) and data indicating the number of new connected vertices (portion 514), as shown in FIG. 5 and described above. The number of bits to read for the first portion (the data identifying the glue vertex) can be determined from the number of boundary vertices that have any existing glue type. This number of boundary vertices that have any existing glue type is known from the intermediate data. The number of bits to read for the second portion (the data identifying the glue type of the glue vertex) can be determined from the number of glue operations remaining for the glue vertex indicated by the first portion. This number of remaining glue operations is known from the intermediate data. The number of bits to read for the third portion (the data indicating the number of new connected vertices) can be determined using the intermediate data, e.g. from the appropriate values of Iₘₐₓ, Lₘₐₓ or Rₘₐₓ. As described above, one or two of these first, second and third portions may be missing where the information for that portion is inherent from the intermediate data (i.e. from the intermediate data it is clear that there is only a single option for the data that would otherwise be identified by the portion and hence the portion can be omitted). In some examples, the sequence of bits that are read in decompression (and written in compression) may be rounded up to a particular size, e.g. for byte/nibble alignment, cache line, stride, block of data, bus width, etc. where only the relevant contents of this larger portion of bits that has been read (or written) are processed in any step. In other examples, there may be a maximum number of bits that a sequence could include (e.g. 4 bits, plus 2 bits, plus 4 bits, giving a total of 12 bits where there is a maximum of 14 vertices in a meshlet) and the method may comprise reading this number of bits at each stage as this guarantees that all information for the step has been read. Again, in such examples, where only the relevant contents of this larger portion of bits that has been read (or written) are processed in any step. In examples where a termination sequence is used in the compression, if this sequence indicates termination (‘Yes’ in 2110), then the entire meshlet has been decompressed and the meshlet topology data (e.g. in the form of primitive data) can be output (block 2118). In other examples, a termination sequence may be optional and termination may, in addition or instead, be determined later in the method using termination criteria based on the intermediate data (in block 2116), as described above with reference to FIG. 3 (block 312).

Where the next sequence does not indicate termination (‘No’ in block 2110), it is then determined, from the sequence of bits, the identity of a glue vertex, the glue type of the glue vertex and a number of new vertices that are connected to the glue vertex (block 2112). As described above, the steps of reading the sequence of bits (block 2108), detecting termination (block 2110) and determining the glue vertex etc. (block 2112) may be performed together rather than as three sequential operations as shown in FIG. 21. As described above, the term ‘new vertex’ or ‘new connected vertex’ refers to vertices that have not already been described in previously read portions of the encoding and hence do not yet exist in the portion of the meshlet that has been decompressed and constructed. Each of the identity of a glue vertex, the glue type of the glue vertex and a number of new vertices that are connected to the glue vertex may be explicitly encoded in the sequence of bits or alternatively one or more of these values may be implicit as a result of the other values that are encoded and/or the current intermediate data (e.g. the current values of V, E, F, B and/or the values of I, L, R for the glue vertex). As described above, the number of new vertices that is encoded may be a relative value (e.g. relative to the minimum possible number of new vertices for the particular glue type). Similarly, the identity of the glue vertex may be encoded in terms of its index or its position relative to a cycle start point vertex around the boundary in, for example, a clockwise order.

As described above, with reference to the compression method, the cycle start point vertex referred is initially the starting vertex. However, if this vertex has a glue type that defines that it is an interior vertex, i.e. a glue type of either (a) ‘Interior glue vertex with no new connected vertices’ or (b) ‘Interior glue vertex with one or more new connected vertices’, then this vertex will no longer be on the boundary after the new vertices are added. In this case, a new cycle start point vertex is chosen based on a pre-defined rule. Any well-defined deterministic rule may be used as long as the same rule is used in both the compression and decompression methods. In an example, the cycle start point vertex moves to the next vertex in the previous boundary in a clockwise direction. As the newly added vertices will have the largest indices, by using this rule, the spatial coherency is maximised.

Having determined the identity of a glue vertex, the glue type of the glue vertex and a number of new vertices that are connected to the glue vertex (in block 2112), additional topology of the meshlet is constructed (block 2114). This construction (in block 2114) comprises adding the identified number of vertices to the identified glue vertex according to the identified glue type and updating the stored intermediate data about the resultant constructed portion of the meshlet including data specific to each of the boundary vertices.

The updates to the intermediate data (in block 2114) are determined based on the glue type and the identified number of connected vertices, v. They are set out in the table below with the updates to the V, E, F, B data for the meshlet shown on in the left column and the updates to the I, L, R data for each boundary vertex shown in the right column:

Interior glue vertex with no new connected vertices

| | |
|---|---|
| V := V | For all vertices on the previous boundary between the current glue vertex and the |
| E := E + 1 | cycle start point vertex in an anticlockwise direction: |
| F := F + 1 | Set the intermediate data to strictly below the current glue type according |
| B := B − 1 | to the pre-defined set of rules defining an order of precedence (see |
| | above). This explicitly removes the possibility of the vertex being an |
| | ‘interior glue vertex with no new connected vertices’. This means that Iₘᵢₙ |
| | is set equal to 1. |
| | In addition, for the vertices that neighboured the current glue vertex on the |
| | previous boundary: |
| | Iₘᵢₙ = 0 |
| | and |
| | Lₘᵢₙ = Rₘᵢₙ = 1 |
| | and |
| | Iₘₐₓ = Lₘₐₓ = Rₘₐₓ = Vₘₐₓ − V |
| | It will be appreciated that this second update (starting ‘in addition’ above) will |
| | override one of the earlier updates (starting ‘for all vertices’ above). In an |
| | implementation, the updates may be stated differently (e.g. so that the first and |
| | second updates operate on separate, non-overlapping, subsets of vertices) as |
| | long as the resultant effect is the same as the two update operations described |
| | above. The same principles also apply to the updates for other glue types |
| | described below. |

Interior glue vertex with one or more new connected vertices

| | |
|---|---|
| V := V + v | For all vertices on the previous boundary between the current glue vertex and the |
| E := E + 2v + 1 | cycle start point vertex in an anticlockwise direction: |
| F := F + v + 1 | Set the intermediate data to strictly below the current glue type according |
| B := B + v − 1 | to the pre-defined set of rules for order of precedence (see above). This |
| | explicitly removes the possibility of the vertex being an ‘interior glue |
| | vertex with no new connected vertices’. This means that Iₘᵢₙ is set equal |
| | to 1. |
| | For all vertices on the previous boundary between the current glue vertex and the |
| | cycle start point vertex in a clockwise direction: |
| | Set the intermediate data to below or the same as the current glue type |
| | according to the pre-defined set of rules for order of precedence (see |
| | above). |
| | In addition, for the vertices that neighboured the current glue vertex on the |
| | previous boundary: |
| | Reduce Iₘₐₓ by 1 |
| | and |
| | For vertex to left, reduce Rₘₐₓ by 1 |
| | and |
| | For vertex to right, reduce Lₘₐₓ by 1 |
| | and |
| | If any maximum was previously 1, then update the intermediate data to |
| | remove this glue option, e.g. by deleting the relevant min and max values |
| | for the glue option or using an invalid state. |
| | In addition, for each vertex on the current boundary (i.e. the boundary after the |
| | addition of the new vertices, as opposed to the previous boundary which is used |
| | in a previous test): |
| | If both the I1+ and L1+ glue type options have been removed, update the |
| | intermediate data to remove availability of the I1+ and R1+ options from |
| | its left neighbour on the current boundary. This may involve setting the |
| | values of Iₘₐₓ and Rₘₐₓ to zero or using an invalid state. |
| | and |
| | If both the I1+ and R1+ glue type options have been removed, update the |
| | intermediate data to remove availability of the I1+ and L1+ options from |
| | its right neighbour on the current boundary. This may involve setting the |
| | values of Iₘₐₓ and Lₘₐₓ to zero or using an invalid state. |
| | and |
| | For all available glue types of vertices on the current boundary, clamp the |
| | associated maximum values (e.g. Iₘₐₓ, Lₘₐₓ and/or Rₘₐₓ) to Vₘₐₓ − V. |

Boundary glue vertex with one or more new connected vertices added on the left

| | |
|---|---|
| V := V + v | For all vertices on the previous boundary between the current glue vertex and the |
| E := E + 2v | cycle start point vertex in an anticlockwise direction: |
| F := F + v | Set the intermediate data to strictly below the current glue type according |
| B := B + v | to the pre-defined set of rules for order of precedence (see above). This |
| | explicitly removes the possibility of the vertex being an ‘interior glue |
| | vertex with no new connected vertices’. This means that Iₘᵢₙ is set equal |
| | to 1. |
| | For all vertices on the previous boundary between the current glue vertex and the |
| | cycle start point vertex in a clockwise direction: |
| | Set the intermediate data to below or to the same as the current glue |
| | type according to the pre-defined set of rules for order of precedence |
| | (see above). |
| | In addition, for the current glue vertex: |
| | Update the intermediate data to remove availability of the current glue |
| | type as well as I0 and I1+. This may involve setting the values of Iₘᵢₙ, Iₘₐₓ, |
| | Lₘᵢₙ and Lₘₐₓ to an invalid state. |
| | In addition, for the vertices that neighboured the current glue vertex on the left on |
| | the previous boundary: |
| | Reduce Iₘₐₓ by 1 |
| | and |
| | Reduce Rₘₐₓ by 1 |
| | and |
| | If any maximum was previously 1, then update the intermediate data to |
| | remove this glue option, e.g. by deleting the relevant min and max values |
| | for the glue option or using an invalid state. |
| | In addition, for each vertex on the current boundary: |
| | If both the I1+ and L1+ glue type options have been removed, update the |
| | intermediate data to remove availability of the I1+ and R1+ options from |
| | its left neighbour on the current boundary. This may involve setting the |
| | values of Iₘₐₓ and Rₘₐₓ to zero or using an invalid state. |
| | and |
| | If both the I1+ and R1+ glue type options have been removed, update the |
| | intermediate data to remove availability of the I1+ and L1+ options from |
| | its right neighbour on the new boundary. This may involve setting the |
| | values of Iₘₐₓ and Lₘₐₓ to zero or using an invalid state. |
| | and |
| | For all available glue types of vertices on the current boundary, clamp the |
| | associated maximum values (e.g. Iₘₐₓ, Lₘₐₓ and/or Rₘₐₓ) to Vₘₐₓ − V. |

Boundary glue vertex with one or more new connected vertices added on the right

| | |
|---|---|
| V := V + v | For all vertices on the previous boundary between the current glue vertex and the |
| E := E + 2v | cycle start point vertex in an anticlockwise direction: |
| F := F + v | Set the intermediate data to strictly below the current glue type according |
| B := B + v | to the pre-defined set of rules for order of precedence (see above). This |
| | explicitly removes the possibility of the vertex being an ‘interior glue |
| | vertex with no new connected vertices’. This means that Iₘᵢₙ is set equal |
| | to 1. |
| | For all vertices on the previous boundary between the current glue vertex and the |
| | cycle start point vertex in a clockwise direction: |
| | Set the intermediate data to below or to the same as the current glue |
| | type according to the pre-defined set of rules for order of precedence |
| | (see above). |
| | In addition, for the current glue vertex: |
| | Update the intermediate data to remove availability of the current glue |
| | type as well as I0 and I1+. This may involve setting the values of Iₘᵢₙ, Iₘₐₓ, |
| | Rₘᵢₙ and Rₘₐₓ to an invalid state. |
| | In addition, for the vertices that neighboured the current glue vertex on the right |
| | on the previous boundary: |
| | Reduce Iₘₐₓ by 1 |
| | and |
| | Reduce Rₘₐₓ by 1 |
| | and |
| | If any maximum was previously 1, then update the intermediate data to |
| | remove this glue option, e.g. by deleting the relevant min and max values |
| | for the glue option or using an invalid state. |
| | In addition, for each vertex on the current boundary: |
| | If both the I1+ and L1+ glue type options have been removed, update the |
| | intermediate data to remove availability of the I1+ and R1+ options from |
| | its left neighbour on the new boundary. This may involve setting the |
| | values of Iₘₐₓ and Rₘₐₓ to zero or using an invalid state. |
| | and |
| | If both the I1+ and R1+ glue type options have been removed, update the |
| | intermediate data to remove availability of the I1+ and L1+ options from |
| | its right neighbour on the new boundary. This may involve setting the |
| | values of Iₘₐₓ and Lₘₐₓ to zero or using an invalid state. |
| | and |
| | For all available glue types of vertices on the current boundary, clamp the |
| | associated maximum values (e.g. Iₘₐₓ, Lₘₐₓ and/or Rₘₐₓ) to Vₘₐₓ − V. |

The method proceeds by continuing to read further sequences of bits of data from the encoding (in further iterations of the loop comprising block 2108, 2112 and 2114), until termination is reached. As described above, termination may be indicated by an explicit termination sequence within the encoding (as detected in block 2110) or as a consequence of termination criteria being reached (as detected in block 2116). These termination criteria are described above with reference to FIG. 3. If the intermediate data indicates that the termination criteria are reached (‘Yes’ in block 2116), then the entire meshlet has been decompressed and the meshlet topology data (e.g. in the form of primitive data) can be output or stored (block 2118). However, if the intermediate data indicates that the termination criteria are not reached (‘No’ in block 2116) then the method continues.

All of the primitives that are generated during the process of decompression, are final primitives (i.e. the decompression uses construction rather than sub-division) and this means that it is possible to output primitive data (including vertex, edge and primitive indices) from the method as soon as a primitive is generated (blocks 2107 and 2113) and before the entire meshlet topology has been determined (i.e. before or instead of block 2118). This is useful for pipelining further per-vertex, per-edge and/or per-primitive processing.

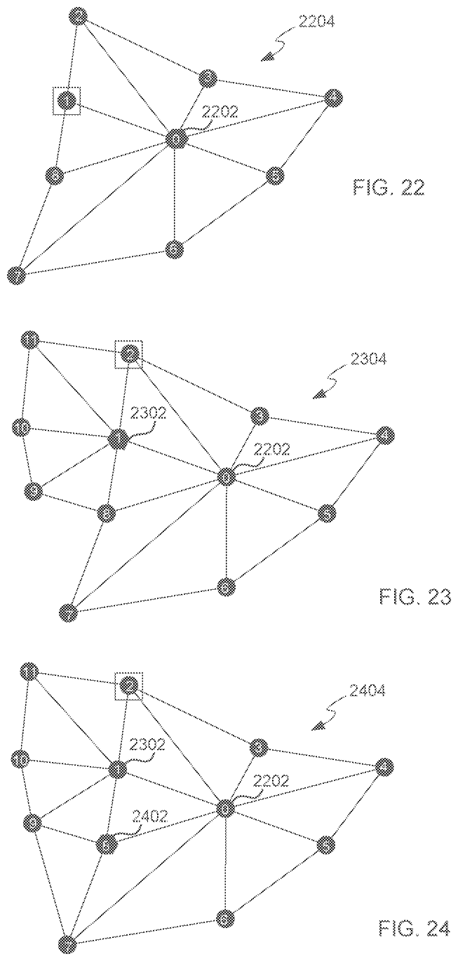

A first example of the decompression method of FIG. 21 can be described with reference to FIGS. 22-26 and the encoding 001010010100110000111011001100 (which is the first of the two example encodings created above, including a termination sequence 100).

The first sequence of bits that is read from the encoding (in block 2102) comprises 5 bits: 00101. The first bit, 0, encodes the glue type of the starting vertex, which is an ‘interior initial vertex with three or more connected vertices’. The remaining 4 bits encode the number of connected vertices, v, in relative form based on the glue type. The four bits 0101 are the binary for 5, which is then added to three (because the minimum number of connected vertices is three), giving v=8. The resultant portion 2204 of the meshlet is shown in FIG. 22, with the starting vertex 2202 shown with index 0 and the connected vertices having indices 1-8. The intermediate data that is stored for this partial meshlet is shown in the two tables below (with the order of the boundary vertices inherently stored in the order of the rows in the second table):

| | |
|---|---|
| V | 9 |
| E | 16 |
| F | 8 |
| B | 8 |

| Vertex | | | | | | |
|---|---|---|---|---|---|---|
| Index | Iₘᵢₙ | Iₘₐₓ | Lₘᵢₙ | Lₘₐₓ | Rₘᵢₙ | Rₘₐₓ |
| 1 | 0 | 5 | 1 | 5 | 1 | 5 |
| 2 | 0 | 5 | 1 | 5 | 1 | 5 |
| 3 | 0 | 5 | 1 | 5 | 1 | 5 |
| 4 | 0 | 5 | 1 | 5 | 1 | 5 |
| 5 | 0 | 5 | 1 | 5 | 1 | 5 |
| 6 | 0 | 5 | 1 | 5 | 1 | 5 |
| 7 | 0 | 5 | 1 | 5 | 1 | 5 |
| 8 | 0 | 5 | 1 | 5 | 1 | 5 |

It can be seen that the value of Imin can be stored as a single bit to indicate 0 or 1, whereas the values of Lₘᵢₙ and Rₘᵢₙ can be stored or can be implicit (and hence not stored in the intermediate data).

The next sequence of bits that is read from the encoding (in block 2108) comprises 6 bits, read in three portions: 0|01|010. As described above, by reading the sequence in portions, the number of additional bits in the sequence that need to be read can be determined. For example, if the first bit is a 1, this indicates early termination and so there are no additional bits to read from the encoding. If the first bit is a 0 and the next two bits (the second portion) are 00, there would be no further bits to read for the sequence. If the first bit is a 0 and the second portion is not 00, then three further bits are read (the third portion) from the encoding to complete the sequence for this stage of the decompression.

In this example, given that the starting vertex was an ‘interior initial vertex with three or more connected vertices’, the allocation of vertex indices is arbitrary and the selection of the next glue vertex is similarly arbitrary, and is given to the vertex with index 1. Consequently, the first portion of this next sequence—the first bit, 0—does not identify the glue vertex but instead indicates whether there is a further glue operation or whether the sequence terminates. In this example, the value 0 indicates that there is a further glue operation. The next two bits, 01, indicate the glue type of the glue vertex, which is an ‘interior glue vertex with one or more new connected vertices’. The final three bits, 010, indicate the number of connected vertices in relative form based on the glue type. The three bits 010 are the binary for 2, which is then added to one (because the minimum number of connected vertices for the glue type is one), giving v=3. The resultant portion 2304 of the meshlet is shown in FIG. 23, with the glue vertex 2302 shown with index 1 (as indicated by the hexagon) and the new connected vertices having indices 9-11. It can be seen that the cycle start point vertex was defined, prior to the addition of the new vertices (according to the rules described above) as vertex 1 (as indicated by the square around the vertex in FIG. 22) and after the addition of the new vertices, the cycle start point vertex moves to vertex 2 (as indicated by the square around the vertex in FIG. 23). The intermediate data that is stored for this partial meshlet is shown in the two tables below:

| | |
|---|---|
| V | 12 |
| E | 23 |
| F | 12 |
| B | 10 |

| Vertex | | | | | | |
|---|---|---|---|---|---|---|
| Index | Iₘᵢₙ | Iₘₐₓ | Lₘᵢₙ | Lₘₐₓ | Rₘᵢₙ | Rₘₐₓ |
| 2 | 0 | 2 | 1 | 2 | 1 | 2 |
| 3 | 1 | 2 | 1 | 2 | 1 | 2 |
| 4 | 1 | 2 | 1 | 2 | 1 | 2 |
| 5 | 1 | 2 | 1 | 2 | 1 | 2 |
| 6 | 1 | 2 | 1 | 2 | 1 | 2 |
| 7 | 1 | 2 | 1 | 2 | 1 | 2 |
| 8 | 0 | 2 | 1 | 2 | 1 | 2 |
| 9 | 0 | 2 | 1 | 2 | 1 | 2 |
| 10 | 0 | 2 | 1 | 2 | 1 | 2 |
| 11 | 0 | 2 | 1 | 2 | 1 | 2 |

As noted above, the value of Iₘᵢₙ can be stored as a single bit to indicate 0 or 1, whereas the values of Lₘᵢₙ and Rₘᵢₙ can be stored or can be implicit (and hence not stored in the intermediate data).

The next sequence of bits that is read, in portions, from the encoding (in block 2108) comprises 6 bits in total: 0110|00. The first portion of this next sequence—the first four bits, 0110—identifies the glue vertex by its index, with the encoded value being relative to the cycle start point which, as described above, moved, prior to the addition of the new vertices (according to the rules described above) from vertex 1 to vertex 2. On the basis of this it can be determined that the glue vertex has an index of 6+2=8. The next two bits, 00, indicate the glue type of the glue vertex, which is an ‘interior glue vertex with no new connected vertices’ (v=0). As a consequence of this glue type there are no bits in the sequence of bits that has been read that indicate the number of connected vertices. The resultant portion 2404 of the meshlet is shown in FIG. 24, with the glue vertex 2402 shown with index 8. The intermediate data that is stored for this partial meshlet is shown in the two tables below:

| | |
|---|---|
| V | 12 |
| E | 24 |
| F | 13 |
| B | 9 |

| Vertex | | | | | | |
|---|---|---|---|---|---|---|
| Index | Iₘᵢₙ | Iₘₐₓ | Lₘᵢₙ | Lₘₐₓ | Rₘᵢₙ | Rₘₐₓ |
| 2 | 0 | 2 | 1 | 2 | 1 | 2 |
| 3 | 1 | 2 | 1 | 2 | 1 | 2 |
| 4 | 1 | 2 | 1 | 2 | 1 | 2 |
| 5 | 1 | 2 | 1 | 2 | 1 | 2 |
| 6 | 1 | 2 | 1 | 2 | 1 | 2 |
| 7 | 0 | 2 | 1 | 2 | 1 | 2 |
| 9 | 0 | 2 | 1 | 2 | 1 | 2 |
| 10 | 0 | 2 | 1 | 2 | 1 | 2 |
| 11 | 0 | 2 | 1 | 2 | 1 | 2 |

It can be seen that the I0 glue type has become available for vertex 7; prior to this it was blocked as an option by the I0 applied to vertex 8.

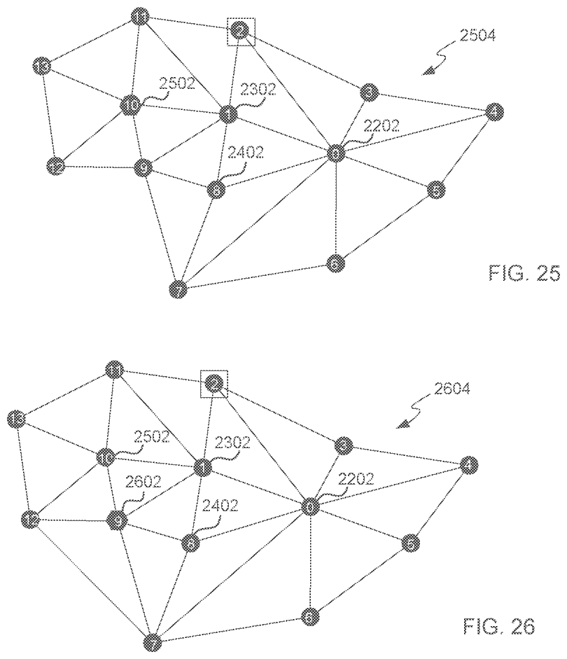

The next sequence of bits that is read from the encoding in portions (in block 2108) comprises 7 bits: 0111|01|1. The first portion of this next sequence—the first four bits, 0111—identifies the glue vertex by its clockwise position in the boundary, with the encoded value being relative to the cycle start point vertex (vertex 2). The first portion identifies that it is the 8th vertex in the boundary working clockwise from the cycle start point (i.e. the 8th row in the table above) which is the vertex with index 10. The next two bits, 01, indicate the glue type of the glue vertex, which is an ‘interior glue vertex with one or more new connected vertices’. The final bit, 1, indicates the number of connected vertices in relative form based on the glue type. The bit value, 1, is then added to one (because the minimum number of connected vertices is one), giving v=2. Only one bit is required to indicate the number of connected vertices, because there are already 12 vertices in the partial meshlet before this glue operation and so the maximum number of new vertices that can be added in this glue operation is 2. The resultant portion 2504 of the meshlet is shown in FIG. 25, with the glue vertex 2502 shown with index 10. The intermediate data that is stored for this partial meshlet is shown in the two tables below:

| | |
|---|---|
| V | 14 |
| E | 29 |
| F | 16 |
| B | 10 |

| | | | | | | |
|---|---|---|---|---|---|---|
| Vertex | | | | | | |
| Index | Iₘᵢₙ | Iₘₐₓ | Lₘᵢₙ | Lₘₐₓ | Rₘᵢₙ | Rₘₐₓ |

| | | |
|---|---|---|
| 2 | | |
| 3 | | |
| 4 | | |
| 5 | | |
| 6 | | |
| 7 | 0 | 0 |
| 9 | 0 | 0 |
| 12 | 0 | 0 |
| 13 | 0 | 0 |
| 11 | 0 | 0 |

A blank cell in the table above indicates an invalid encoding is used to represent this state. If all cells are blank for an entire row, as is the case for many of the vertices above, this boundary vertex can be excluded from consideration as the glue vertex as this indicates that there are no available glue types for this vertex.

The next sequence of bits that is read in portions from the encoding (in block 2108) comprises 3 bits: 001. These three bits identify the glue vertex by its index, with the encoded value being relative to the cycle start point which moved, prior to the addition of the new vertices (according to the rules described above) from vertex 1 to vertex 2. This indicates that the glue vertex is the 2^{nd} boundary vertex in the table above, ignoring the empty rows, i.e. the vertex with index 9. As the partial meshlet already contains the maximum possible number of vertices (V=Vₘₐₓ), then there is only one possible glue type—an ‘interior glue vertex with no new connected vertices’—and the number of connected vertices follows on directly from this (v=0). Consequently, this sequence of bits comprises only a single portion. The resultant portion 2604 of the meshlet is shown in FIG. 26, with the glue vertex 2602 shown with index 9. The intermediate data that is stored for this partial meshlet is shown in the two tables below:

| | |
|---|---|
| V | 14 |
| E | 30 |
| F | 17 |
| B | 9 |

| | | | | | | |
|---|---|---|---|---|---|---|
| Vertex | | | | | | |
| Index | Iₘᵢₙ | Iₘₐₓ | Lₘᵢₙ | Lₘₐₓ | Rₘᵢₙ | Rₘₐₓ |

| | | |
|---|---|---|
| 2 | | |
| 3 | | |
| 4 | | |
| 5 | | |
| 6 | | |
| 7 | 0 | 0 |
| 12 | 0 | 0 |
| 13 | 0 | 0 |
| 11 | 0 | 0 |

In this case, despite the maximum number of vertices being reached (V=Vₘₐₓ), there are still four vertices which could be used as glue vertices without adding new vertices as their values of Iₘᵢₙ are zero, as shown in the intermediate data above. This means that the intermediate data does not indicate termination (‘No’ in block 2116). If, however, the smallest value of Iₘᵢₙ for all boundary vertices was equal to or greater than one, then the intermediate data would indicate termination of the encoding (‘Yes’ in block 2116).

The next sequence of bits that is read from the encoding (in block 2108) comprises the remaining 3 bits: 100. These three bits are a termination sequence (‘Yes’ in block 2110) and so the topology shown in FIG. 26 is the full topology of the meshlet and this topology can be stored or output (in block 2118).

A second example of the decompression method of FIG. 21 can be described with reference to FIGS. 27-32 and the encoding 10011000001010111011011110000100011. In this example, instead of leaving blank rows in the tables showing a representation of the intermediate data, these rows are deleted from the table because the vertex that corresponds to the blank/deleted row cannot be considered as a future glue vertex. There may be situations where such a vertex becomes available again, e.g. due to a neighbouring glue operation blocking further connections and in which case, the row is subsequently reinstated within the tables shown.

The first sequence of bits that is read portion-by-portion from the encoding (in block 2102) comprises 5 bits: 1|0011. The first bit, 1, encodes the glue type of the starting vertex, which is a ‘boundary initial vertex with two or more connected vertices’. The remaining 4 bits encode the number of connected vertices, v, in relative form based on the glue type. The four bits 0011 are the binary for 3, which is then added to two (because the minimum number of connected vertices is two), giving v=5. The resultant portion 2704 of the meshlet is shown in FIG. 27, with the starting vertex 2702 shown with index 0 and the connected vertices having indices 1-5. The current cycle start point vertex (in this case the starting vertex) is shown as a square in FIG. 27, whereas other vertices are shown as circles. As a consequence of the glue type, the edges between vertex 0 and vertices 1 and 5 must be on the boundary of the meshlet itself and so these are shown with thicker lines in FIG. 27. The intermediate data that is stored for this partial meshlet is shown in the two tables below (with the order of the boundary vertices inherently stored in the order of the rows in the second table):

| | |
|---|---|
| V | 6 |
| E | 9 |
| F | 4 |
| B | 6 |

| Vertex | | | | | | |
|---|---|---|---|---|---|---|
| Index | Iₘᵢₙ | Iₘₐₓ | Lₘᵢₙ | Lₘₐₓ | Rₘᵢₙ | Rₘₐₓ |
| 1 | | | | | 1 | 8 |
| 2 | 0 | 8 | 1 | 8 | 1 | 8 |
| 3 | 0 | 8 | 1 | 8 | 1 | 8 |
| 4 | 0 | 8 | 1 | 8 | 1 | 8 |
| 5 | | | 1 | 8 | | |

As noted above, the value of Iₘᵢₙ can be stored as a single bit to indicate 0 or 1, whereas the values of Lₘᵢₙ and Rₘᵢₙ can be stored or can be implicit (and hence not stored in the intermediate data). Furthermore, an empty cell in the table above indicates that an invalid encoding is used to represent this state and as described above, in this example, blank rows (in this case for vertex 0) have been deleted as they represent vertices that are excluded from future consideration as a glue vertex.

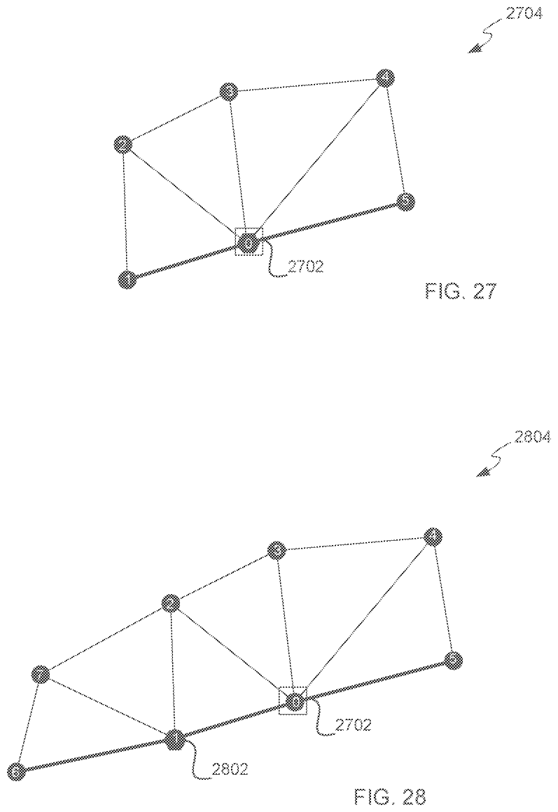

The next sequence of bits that is read, in portions, from the encoding (in block 2108) comprises 6 bits: 000|001. Given that the starting vertex was a ‘boundary initial vertex with two or more connected vertices’, the allocation of vertex indices is not arbitrary and the selection of the next glue vertex is similarly not arbitrary. Consequently, the first portion of this next sequence—the first three bits, 000—identify the glue vertex. In this example, the value 000 indicates the 1st boundary vertex in the list with available glue types, i.e. the vertex with an index of 1. Given that the starting vertex was a ‘boundary initial vertex with two or more connected vertices’, the glue type of the new glue vertex (vertex 1) can only be one type—a ‘boundary glue vertex with one or more new connected vertices added on the left’—and so this does not need to be encoded in the sequence of bits. The remaining three bits from the sequence that has been read, 001, indicate the number of connected vertices in relative form based on the glue type. The three bits 001 are the binary for one, which is then added to one (because the minimum number of connected vertices is one), giving v=2. The resultant portion 2804 of the meshlet is shown in FIG. 28, with the glue vertex 2802 shown with index 1 and the new connected vertices having indices 6-7. As a consequence of the glue type, the edges between vertex 1 and vertex 6 must be on the boundary of the meshlet itself and so this edge is shown with a thicker line in FIG. 28. The intermediate data that is stored for this partial meshlet is shown in the two tables below:

| | |
|---|---|
| V | 8 |
| E | 13 |
| F | 6 |
| B | 8 |

| Vertex | | | | | | |
|---|---|---|---|---|---|---|
| Index | Iₘᵢₙ | Iₘₐₓ | Lₘᵢₙ | Lₘₐₓ | Rₘᵢₙ | Rₘₐₓ |
| 6 | | | | | 1 | 6 |
| 7 | 0 | 6 | 1 | 6 | 1 | 6 |
| 2 | 0 | 0 | 1 | 1 | 1 | 2 |
| 3 | 1 | 1 | 1 | 2 | 1 | 2 |
| 4 | 1 | 1 | 1 | 2 | 1 | 2 |
| 5 | | | 1 | 2 | | |

It can be seen that when updating the intermediate data, the maximum number of added vertices for all those vertices that were present when the next glue vertex (vertex 1) was selected (vertices 2-5) have had their maximum number of added vertices reduced from 8 to 2. This is because of the pre-defined rules for selecting the next glue vertex. Had any of these vertices had more than 2 connected vertices, they would have been selected as the next glue vertex instead of vertex 1. By similar reasoning, Iₘₐₓ is reduced to 1 for those boundary vertices. For vertex 2, Lₘₐₓ is reduced further to one because the glueing operation has just added one connected vertex to the left of vertex 2 and Iₘₐₓ is similarly decremented (from 1 to 0). Similarly, the minimum number of added vertices for vertices 3-5 has been increased from zero to one, because had they been of the glue type ‘interior glue vertex with no new connected vertices’, they again would have been selected as the next glue vertex instead of vertex 1 according to the pre-defined rules for selecting the next glue vertex. This assumption cannot be applied to vertex 2 because its situation has changed with the addition of the new vertices with indices 6 and 7.

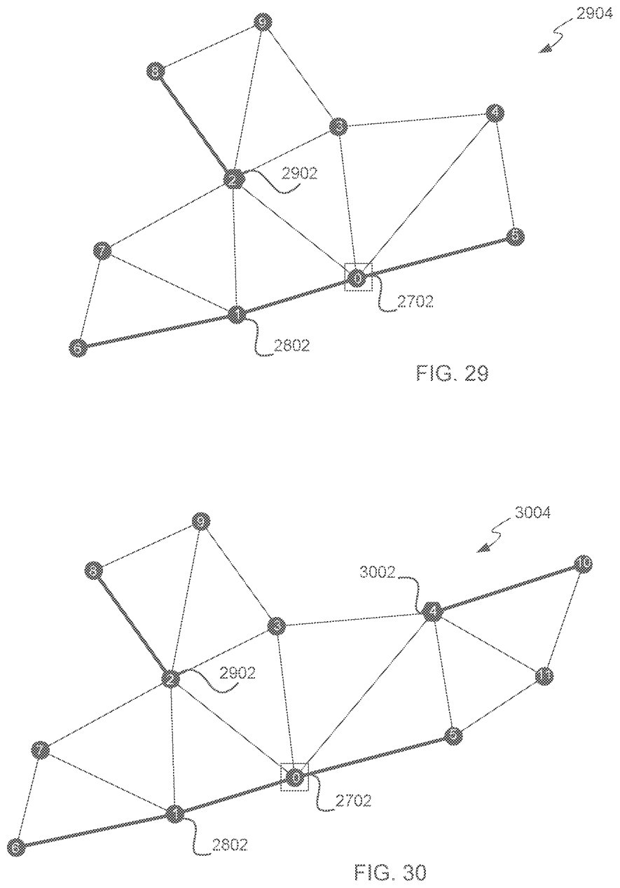

The next sequence of bits that is read in portions from the encoding (in block 2108) comprises 6 bits: 010|11|1. The first portion of this next sequence—the first three bits, 010—identify the glue vertex as the third in the table above, which is the vertex having index 2. The next two bits—11—indicate the glue type as being a ‘boundary glue vertex with one or more new connected vertices added on the right’. The remaining one bit from the sequence that has been read, 1, indicates the number of connected vertices in relative form based on the glue type which has a minimum of one new connected vertex, so that 1+1=2 (v=2). The resultant portion 2904 of the meshlet is shown in FIG. 29, with the glue vertex 2902 shown with index 2 and the new connected vertices having indices 8-9. As a consequence of the glue type, the edges between vertex 2 and vertex 8 must be on the boundary of the meshlet itself and so this edge is shown with a thicker line in FIG. 29. The intermediate data that is stored for this partial meshlet is shown in the two tables below:

| | |
|---|---|
| V | 10 |
| E | 17 |
| F | 8 |
| B | 10 |

| Vertex | | | | | | |
|---|---|---|---|---|---|---|
| Index | Iₘᵢₙ | Iₘₐₓ | Lₘᵢₙ | Lₘₐₓ | Rₘᵢₙ | Rₘₐₓ |
| 6 | | | | | 1 | 1 |
| 7 | 1 | 1 | 1 | 1 | 1 | 1 |
| 2 | | | 1 | 1 | | |
| 8 | | | | | 1 | 4 |
| 9 | 0 | 4 | 1 | 4 | 1 | 4 |
| 3 | 0 | 0 | 1 | 1 | 1 | 2 |
| 4 | 1 | 1 | 1 | 2 | 1 | 2 |
| 5 | | | 1 | 2 | | |

The next sequence of bits that is read in portions from the encoding (in block 2108) comprises 7 bits: 0110|11|1. The first portion of this next sequence—the first four bits, 0110—identify the glue vertex as the 7^{th} in the table above, i.e. the vertex having index 4. The next two bits—11—indicate the glue type as being a ‘boundary glue vertex with one or more new connected vertices added on the right’. The remaining one bit from the sequence that has been read, 1, indicates the number of connected vertices in relative form based on the glue type which has a minimum of one new connected vertex, so that 1+1=2 (v=2). The resultant portion 3004 of the meshlet is shown in FIG. 30, with the glue vertex 3002 shown with index 4 and the new connected vertices having indices 10-11. As a consequence of the glue type, the edges between vertex 4 and vertex 10 must be on the boundary of the meshlet itself and so this edge is shown with a thicker line in FIG. 30. The intermediate data that is stored for this partial meshlet is shown in the two tables below:

| | |
|---|---|
| V | 12 |
| E | 21 |
| F | 10 |
| B | 12 |

| Vertex | | | | | | |
|---|---|---|---|---|---|---|
| Index | Iₘᵢₙ | Iₘₐₓ | Lₘᵢₙ | Lₘₐₓ | Rₘᵢₙ | Rₘₐₓ |
| 6 | | | | | 1 | 1 |
| 7 | 1 | 1 | 1 | 1 | 1 | 1 |
| 2 | | | 1 | 1 | | |
| 8 | | | | | 1 | 1 |
| 9 | 1 | 1 | 1 | 1 | 1 | 1 |
| 3 | 0 | 0 | 1 | 1 | 1 | 1 |
| 4 | | | 1 | 1 | | |
| 10 | | | | | 1 | 2 |
| 11 | 0 | 2 | 1 | 2 | 1 | 2 |
| 5 | | | 1 | 1 | | |

The next sequence of bits that is read in portions from the encoding (in block 2108) comprises 7 bits: 1000|01|0. The first portion of this next sequence—the first four bits, 1000—identify the glue vertex as being the 9th in the table above, i.e. the vertex having index 11. The next two bits—01—indicate the glue type as being an ‘interior glue vertex with one or more new connected vertices’. The remaining one bit from the sequence that has been read, 0, indicates the number of connected vertices in relative form based on the glue type which has a minimum of one new connected vertex, so that 0+1=1 (v=1). The resultant portion 3104 of the meshlet is shown in FIG. 31, with the glue vertex 3102 shown with index 11 and the new connected vertex having index 12. The intermediate data that is stored for this partial meshlet is shown in the two tables below:

| | |
|---|---|
| V | 13 |
| E | 24 |
| F | 12 |
| B | 12 |

| Vertex | | | | | | |
|---|---|---|---|---|---|---|
| Index | Iₘᵢₙ | Iₘₐₓ | Lₘᵢₙ | Lₘₐₓ | Rₘᵢₙ | Rₘₐₓ |
| 6 | | | | | 1 | 1 |
| 7 | | | 1 | 1 | 1 | 1 |
| 2 | | | 1 | 1 | | |
| 8 | | | | | 1 | 1 |
| 9 | | | 1 | 1 | 1 | 1 |
| 3 | | | 1 | 1 | 1 | 1 |
| 4 | | | 1 | 1 | | |
| 12 | 0 | 0 | | | | |

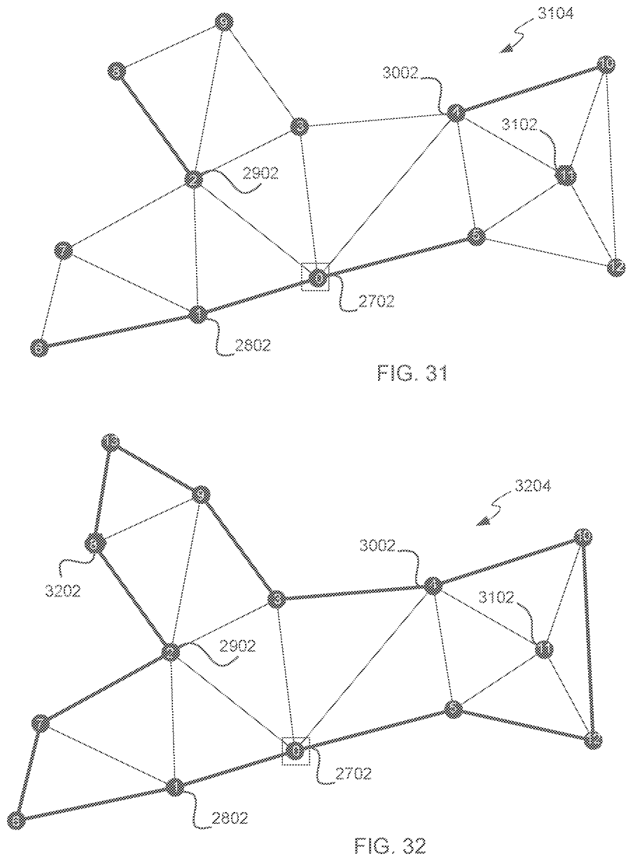

The next sequence of bits that is read in portions from the encoding (in block 2108) comprises 4 bits: 0011. The four bits identify the glue vertex as the 4th in the table above, i.e. the vertex having index 8. As a consequence of the stored intermediate data for this vertex (shown in the table above), there is only one possible glue type—a ‘boundary glue vertex with one or more new connected vertices added on the right’—and there has to be exactly one new connected vertex (v=1). Data identifying the glue type and number of connected vertices therefore does not need to be included in the encoding. The resultant portion 3204 of the meshlet is shown in FIG. 32, with the glue vertex 3202 shown with index 8 and the new connected vertex having index 13. The intermediate data that is stored for this partial meshlet is shown in the two tables below:

| | |
|---|---|
| V | 14 |
| E | 26 |
| F | 13 |
| B | 13 |

| | | | | | | |
|---|---|---|---|---|---|---|
| Vertex Index | Iₘᵢₙ | Iₘₐₓ | Lₘᵢₙ | Lₘₐₓ | Rₘᵢₙ | Rₘₐₓ |

All boundary rows are excluded from consideration so there are no rows in the second table above.

At this point, the intermediate data indicates termination (‘Yes’ in block 2116) since there are no glue types that any of the vertices can have (as indicated by the lack of any rows in the table above). This means that the topology shown in FIG. 32 is the full topology of the meshlet and this topology can be stored or output (in block 2118).

It will be appreciated that the way in which the intermediate data is stored in the examples above provides just one example of how the data may be stored. The intermediate data may alternatively be stored in a different way. For example, the intermediate data may be stored as individual tables of I, L, R minimum and maximum values for each boundary vertex and the order of the boundary vertices may be separately stored, for example with the V, E, F, B data. In other examples, the I, L, R maximum values may be stored and the I, L, R minimum values may not be stored and instead a bit may be stored to indicate whether for the particular vertex, the I0 glue type is available or not. In some examples, instead of a clockwise boundary order, an anticlockwise or other order may be used for boundary vertices (e.g. ordered by vertex index which may mean that the indices can be omitted from the tables above). Storing the intermediate data does not require a lot of space, for example, for Vₘₐₓ=14, a maximum of around 264 bits may be allocated for compression/decompression (e.g. ~19 bits for the V, E, F, B data dependent upon the maximum values of V, E, F and B, up to ~56 bits for a list of the current boundary vertices dependent upon the maximum number of boundary vertices, up to ~182 bits for the 10 bit and the I, L, R maximum values for each boundary vertex, again dependent upon the maximum number of boundary vertices, and up to ~41 bits for the codeword and, optionally, an index indicating where we are currently iterated to).

It will be appreciated that the use of relative indices and/or relative numbers of new connected vertices is optional and furthermore, where relative (rather than absolute) values are used, they may be calculated in a different way to the manner used in the examples above.

It can be seen from the table below that even though the encoding for the meshlet shown in FIG. 32 does not require a termination sequence, its encoding is longer than the shorter of the two encodings for the meshlet shown in FIG. 4 which includes a 3-bit termination sequence. Furthermore, if considering the length of the encodings per edge/face in the meshlet (e.g. to give edges per bit and faces per bit) the difference between the two encodings is significant because the meshlet in FIG. 32, with the longer encoding, has fewer edges and faces (e.g. 13 faces compared to 17 faces).

| Meshlet | Encoding |
|---|---|
| FIG. 4 | 001011010100110000111011001100 |
| | (includes termination sequence) |
| FIG. 32 | 10011000001010111011011110000100011 |

This is because the meshlet in FIG. 32 is a less “well-behaved” shape than the meshlet in FIG. 4. A first meshlet may be considered more well-behaved than a second meshlet if the value of B/V for the first meshlet is smaller—i.e. a smaller proportion of the vertices in the first meshlet are boundary vertices than the second meshlet. For the meshlet in FIG. 4, B/V=9/14=~0.6, whereas for the meshlet in FIG. 32, B/V=13/14=~0.9. In another example, a first meshlet may be considered more well-behaved than a second meshlet if it has a higher face-to-vertex ratio. For the meshlet in FIG. 4, faces: vertices=17:14 (so faces/vertices=~1.2), whereas for the meshlet in FIG. 32, vertices=13:14 (so faces/vertices=~0.9). More well-behaved meshlets are likely to be more common in practical applications than less well-behaved meshlets (and/or mesh segmentation algorithms can be designed to prioritize generation of meshlets that are more well-behaved compared to alternative less well-behaved meshlets wherever possible) and so by developing a compression method that produces shorter encodings for well-behaved meshlets, the overall average amount of compression that is achievable is increased.

When performing decompression, as described above with reference to FIG. 21, the edge and primitive indices may be determined as follows. For primitive indices, the two main (open/closed) fan orderings are contiguously clockwise (as in the examples above) or contiguously anticlockwise. Alternatively, any other well-defined rule may be used, as long as the same rule is used for both compression and decompression. Similarly, for edge indices/orderings, the ordering can be clockwise or anticlockwise as for primitives, but the following rule may be used for the newly connected (open/closed) fan: all of the “star” followed by all of the “link” or vice versa, where the “star” comprises those edges which fan out from the glue vertex and the “link” comprises those edges which connect the distal ends of the edges in the “star” (i.e. the edges that connect the ends of the edges in the “star” which are not at the glue vertex). In other examples, a different ordering may be used, e.g. interleaving the “star” and “link”. i.e. “inside”, “outside”, “inside”, . . . and so on. Alternatively, any other well-defined rule may be used, as long as the same rule is used for both compression and decompression.

The indexing/ordering used for vertices and primitives using the methods described herein may differ between the original submission order and the output order after decompression. This does not affect how a triangle primitive will be rendered (e.g. rasterised or intersected by a ray) but in case a shader intrinsic references a primitive or vertex using the original order, additional data may be stored. For example, the methods described herein may additionally store a mapping between the new primitive order and the original submission order (per meshlet). The methods described herein may in addition, or instead, store a mapping between the original vertex order and the original submission order (per primitive). This can be done with only 2 or 3 bits (3 or 6 states respectively) per primitive. This additional stored mapping data does not need to be stored as part of the compressed meshlet encoding for the purposes of rasterisation or ray-tracing traversal, as they do not affect the fixed-function rendering operations (the correct coordinate data will still be referenced). Instead, the topology encoding can be kept in local on-chip memory during rasterisation/RT traversal. The additional mapping/ordering data may be stored in less local memory, and only fetched for shader execution as and when required (e.g., when a shader intrinsic requires it, plus when it is known that the primitive is “seen” i.e. after frustum culling has occurred in rasterisation, or once a ray intersection has been found in ray tracing.)

In the examples described above, it is assumed that a meshlet has “consistent winding”, i.e. if primitives 1 and 2 are connected by a shared edge with unordered endpoints {A, B}, then we have edge “A->B” in primitive 1, and edge “B−>A” in primitive 2, or vice versa. In a variation of the methods described above, this requirement may be relaxed, in which case an additional bit may be stored per primitive to modify the winding of the primitive where required. In such examples, the different winding types may be defined as follows, for three vertices 0, 1, and 2 in a primitive:

$$0 , 1 , 2 \text{<->} 1 , 2 , 0 \text{<->} 2 , 0 , 1 - winding type 1$$

$$0 , 2 , 1 \text{<->} 2 , 1 , 0 \text{<->} 1 , 0 , 2 - winding type 2$$

The winding type may be identified during compression, when the initial glue operation is performed to add connected vertices and establish an oriented boundary (i.e., concepts of clockwise/anticlockwise, next/previous, left/right, etc.). The oriented boundary is established to be consistent with the winding of the original uncompressed primitives.

The methods of compression and decompression described above may be implemented in software or hardware. In various implementations, the compression method may be implemented offline whereas the decompression method may be implemented on-the-fly (e.g. at runtime). A dedicated decompression hardware unit may be used to implement the decompression method within a graphics processing unit or other processing unit.

In the methods described above, there is an upper limit on the number of vertices per meshlet, Vₘₐₓ, which enables further compression by reducing the options at each stage of compression/decompression and so reducing the number of bits required to encode each successive iteration of the compression method. There is no explicit limit on the number of primitives within a meshlet; however, there will be an upper bound that which is implied by the maximum number of vertices. In variations on the methods described above, the hard limit may instead be on the number of edges (E) or primitives (F) and/or a hard limit on any non-empty subset of V, E and F (i.e. a hard limit on both E and F, or both V and F, or both V and E or on all of V, E and F).

The above methods do not cover the situation where a meshlet comprises a single triangle primitive (i.e. it is always assumed that a meshlet comprises at least two triangle primitives). In a variation of the methods described above, a special encoding may be used (e.g. instead of the initial glue types identified above) to indicate a meshlet that comprises a single triangle primitive, e.g., where this might occur as output from a mesh segmentation algorithm.

The methods described above inherently use a variable-length encoding for the glue type (e.g. there are zero bits read for the glue type in FIG. 28); however variable-length encoding is not used for other portions of the sequences within an encoding. In a variation on the methods described above, variable length encoding may additionally be used for one or more additional portions of the sequences within an encoding, e.g. for one or more of the glue vertex and the number of connected vertices. By increasing the use of variable length encoding, this reduces the redundancy further, at the expense of additional muxing.

For example, given potential glue vertices {6, 7, 2, 8, 9, 3, 4, 12, −1}, as in FIG. 31 and where −1 is the termination sequence, then rather than using the fixed-length encoding:

$$6 \text{<->} 0000$$

$$7 \text{<->} 0001$$

$$2 \text{<->} 0010$$

$$8 \text{<->} 0011$$

$$9 \text{<->} 0100$$

$$3 \text{<->} 0101$$

$$4 \text{<->} 0110$$

$$12 \text{<->} 0111$$

$$- 1 \text{<->} 1000$$

the following (prefix-free) variable-length encoding could be used:

$$6 \text{<->} 000$$

$$7 \text{<->} 001$$

$$2 \text{<->} 010$$

$$8 \text{<->} 011$$

$$9 \text{<->} 100$$

$$3 \text{<->} 101$$

$$4 \text{<->} 110$$

$$12 \text{<->} 1110$$

$$- 1 \text{<->} 1111$$

This variable length encoding could be used to penalise two kinds of glue vertex with longer encodings: (1) Vertices further round the boundary from the cycle start point vertex, which are less likely to be selected due to the order of precedence tiebreak; and (2) The termination bit sequence (index −1), where a mesh segmentation algorithm is expected to fill a meshlet with as much geometry as possible up to the hard limit(s). Whilst this example shows variable length encoding for the glue vertex, a similar technique could be used for third portion of a sequence, the number of connected vertices.

By using the methods described above, compression of the meshlet topology data by up to ten times may be achieved (e.g. when comparing to a geometry block with an explicit edge list, as pairs of vertex indices, and an explicit primitive list, as triples of vertex/edge indices) with well-behaved meshlets being compressed more than less well-behaved meshlets.

FIG. 33 shows a computer system in which the graphics processing systems described herein may be implemented. The computer system comprises a CPU 3302, a GPU 3304, a memory 3306, a neural network accelerator (NNA) 3308 and other devices 3314, such as a display 3316, speakers 3318 and a camera 3322. A decompression hardware block 3310 is implemented on the GPU 3304 and is arranged to implement the decompression method described herein. The compression method described herein may also be implemented within the GPU 3304 (e.g. in a compression hardware block 3312). In other examples, one or more of the depicted components may be omitted from the system, and/or the decompression hardware block 3310 and/or compression hardware block 3312 may be implemented on the CPU 3302 or within the NNA 3308. The encodings that are generated using the compression methods described herein may be stored in the memory 3306. The components of the computer system can communicate with each other via a communications bus 3320.

FIG. 33B shows a more detailed graphical representation of the decompression hardware block 3310 which may perform on-the-fly decompression within the GPU 3304. As shown in FIG. 33B, the decompression hardware block 3310 comprises hardware logic 3332 arranged to read a next sequence of the input code 3333 and pass it to hardware logic 3334 arranged to determine the glue operation. This hardware logic 3334 extracts the code portions that identify the glue vertex index, the glue type and the number of new connected vertices from the code sequence it receives. The decompression hardware block 3310 also comprises hardware logic 3336 configured to perform the glue operation using the three code portions received from the hardware logic 3334 that determines the glue operation. The hardware logic 3336 that performs the glue operation generates and outputs the edge indices to an edge index buffer 3338 and the primitive indices to a primitive index buffer 3340. The decompression hardware block 3310 also comprises hardware logic 3342 configured to perform an update operation on the data that is stored and used by the hardware logic 3334 that determines the glue operation and the hardware logic 3336 that performs the glue operation. The update operation involves updating the maximum (and possibly minimum) values for I, L and R for each boundary vertex 3344 and the values of V, E, F and B 3346 as described above. FIG. 33B also shows sideband data which bypasses the meshlet topology decompression unit. This sideband data is the raw coordinate data for each of the vertices (e.g. primarily, an (x, y, z) coordinate, but it may also include other vertex attributes). During compression (which may be performed offline), as the meshlet is reordered, in terms of the indices used to refer to each vertex, the associated vertex coordinate data is reordered to match this. Hence, when performing (online) on-the-fly decompression, the vertex indices in the edge and primitive index buffers already directly reference the correct coordinates in the data structure without modification (as indicated by the arrows from blocks 3338 and 3340 to block 3344).

The computer system of FIG. 33A and decompression hardware block of FIG. 33B are shown as comprising a number of functional blocks. This is schematic only and is not intended to define a strict division between different logic elements of such entities. Each functional block may be provided in any suitable manner. It is to be understood that intermediate values described herein as being formed by a particular block need not be physically generated by the block at any point and may merely represent logical values which conveniently describe the processing performed by the computer system between its input and output.

A first further aspect provides a method of compressing meshlet topology data comprising: (i) selecting a starting vertex in a meshlet; (ii) create an encoding comprising data identifying a glue type of the starting vertex and data indicating a number of connected vertices, wherein the glue type of a vertex defines a relative arrangement of the vertex and the connected vertices and wherein each connected vertex is connected to the starting vertex by an edge; (iii) selecting a next glue vertex in the meshlet; (iv) for the next glue vertex, appending to the encoding, one or more of: data identifying the next glue vertex; data identifying a glue type of the next glue vertex and data indicating a number of new connected vertices, wherein each new connected vertex is connected to the new glue vertex by an edge; and (v) repeating steps (iii) and (iv) until all the vertices and edges of the meshlet are included in the encoding.

A next glue vertex in the meshlet may be selected using pre-defined selection rules.

The method may further comprise: appending a pre-defined termination sequence to the encoding.

The method may further comprise: determining whether the meshlet satisfies pre-defined termination criteria; and in response to determining that the meshlet does not satisfy the pre-defined termination criteria, appending a pre-defined termination sequence to the encoding.

The method may further comprise: in response to determining that the meshlet satisfies the pre-defined termination criteria, outputting the encoding without appending a termination sequence to the encoding.

The glue type of the starting vertex may be either an interior initial vertex with three or more connected vertices or a boundary initial vertex with two or more connected vertices.

The glue type of a next glue vertex may be one of: an interior glue vertex with no new connected vertices; an interior glue vertex with one or more new connected vertices; a boundary glue vertex with one or more new connected vertices added on the left; and a boundary glue vertex with one or more new connected vertices added on the right.

The method may further comprise: (vi) storing the encoding; (vii) selecting a different starting vertex and repeating steps (ii)-(vi) for the different starting vertex; (viii) selecting a shortest stored encoding for the meshlet.

The meshlet may be homeomorphic to the topologically closed unit disc.

The method may further comprise, prior to selecting a starting vertex in a meshlet: sub-dividing a complex meshlet into a plurality of meshlets, wherein the complex meshlet is not homeomorphic to the topologically closed unit disc and each of the plurality of meshlets is homeomorphic to the topologically closed unit disc; and performing steps (i)-(v) for each of the plurality of meshlets.

The method may be implemented in an offline processing by a computing device.

A second further aspect provides a method of decompressing compressed meshlet topology data comprising: (i) reading a first sequence of bits from an encoding of a meshlet; (ii) determining, from the sequence of bits, a glue type of a starting vertex and data indicating a number of connected vertices, wherein the glue type of a vertex defines a relative arrangement of the vertex and the connected vertices and wherein each connected vertex is connected to the starting vertex by an edge; (iii) adding the identified number of connected vertices to the starting vertex to form a portion of the meshlet, the portion of the meshlet comprising a plurality of primitives, and storing intermediate data for the portion of the meshlet; (iv) reading a next sequence of bits from the encoding; (v) determining, from the sequence of bits and the intermediate data, a glue vertex in the portion of the meshlet, a glue type of the glue vertex and data indicating a number of new connected vertices, wherein each connected vertex is connected to the glue vertex by an edge; (vi) adding the identified number of new connected vertices to the portion of the meshlet according to the glue type of the glue vertex, and updating intermediate data for the portion of the meshlet; (vii) repeating steps (iv)-(vi) until the sequence or the intermediate data indicates termination; (viii) outputting the decompressed meshlet topology data.

Outputting the decompressed meshlet topology data may comprise: outputting the decompressed meshlet topology data for the portion of the meshlet prior to reading a next sequence of bits from the encoding.

The intermediate data may comprise: a number of vertices in the portion of the meshlet; a number of edges in the portion of the meshlet; a number of primitives in the portion of the meshlet; and a number of vertices on a boundary of the portion of the meshlet.

Pre-defined selection rules may be used to determine, from the sequence of bits and the intermediate data, a glue vertex in the portion of the meshlet, a glue type of the glue vertex and data indicating a number of new connected vertices.

The first sequence of bits may comprise a pre-defined number of bits and wherein each next sequence of bits comprises a variable number of bits, wherein the number of bits in a next sequence is determined using the intermediate data.

The sequence of bits may comprise one or more of: one or more bits identifying a glue vertex in the portion of the meshlet; one or more bits indicating a glue type of the glue vertex; and one or more bits indicating a number of new connected vertices.

The sequence of bits may comprise one or two of: one or more bits identifying a glue vertex in the portion of the meshlet; one or more bits indicating a glue type of the glue vertex; and one or more bits indicating a number of new connected vertices, and wherein the method further comprises inferring one or more of an identity of the glue vertex in the portion of the meshlet, a glue type of the glue vertex and the number of new connected vertices using the intermediate data.

A third further aspect provides hardware logic arranged to decompress compressed meshlet topology data comprising: a first hardware logic block arranged to read a first sequence of bits from an encoding of a meshlet; a second hardware logic block arranged to determine, from the sequence of bits received from the first hardware logic block, a glue type of a starting vertex and data indicating a number of connected vertices, wherein the glue type of a vertex defines a relative arrangement of the vertex and the connected vertices and wherein each connected vertex is connected to the starting vertex by an edge; a third hardware logic block arranged to add the identified number of connected vertices to the starting vertex to form a portion of the meshlet, the portion of the meshlet comprising a plurality of primitives, and a fourth hardware logic block arranged to generate and store intermediate data for the portion of the meshlet, wherein the first hardware logic block is further arranged to read a next sequence of bits from the encoding, the second hardware logic block is further arranged to determine, from the next sequence of bits and the intermediate data, a glue vertex in the portion of the meshlet, a glue type of the glue vertex and data indicating a number of new connected vertices, wherein each connected vertex is connected to the glue vertex by an edge, the third hardware logic block is further arranged to add the identified number of new connected vertices to the portion of the meshlet according to the glue type of the glue vertex, and the fourth hardware logic block is further arranged to generate and store updated intermediate data for the portion of the meshlet.

The third hardware logic block may be further arranged to output the decompressed meshlet topology data.

The intermediate data may comprise: a number of vertices in the portion of the meshlet; a number of edges in the portion of the meshlet; a number of primitives in the portion of the meshlet; and a number of vertices on a boundary of the portion of the meshlet.

The second hardware logic may be configured to use pre-defined selection rules to determine, from the sequence of bits and the intermediate data, a glue vertex in the portion of the meshlet, a glue type of the glue vertex and data indicating a number of new connected vertices.

The first sequence of bits may comprise a pre-defined number of bits and wherein each next sequence of bits comprises a variable number of bits, wherein the number of bits in a next sequence is determined using the intermediate data.

The sequence of bits may comprise one or more of: one or more bits identifying a glue vertex in the portion of the meshlet; one or more bits indicating a glue type of the glue vertex; and one or more bits indicating a number of new connected vertices.

A fourth further aspect provides a graphics processing unit comprising the hardware logic described herein.

A fifth further aspect provides computer readable code configured to cause one of the methods described herein to be performed when the code is run. The computer readable code may be provided encoded on a computer readable storage medium.

The decompression and compression hardware blocks described herein may be embodied in hardware on an integrated circuit. The decompression and compression hardware blocks described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be or comprise any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a decompression and/or compression hardware block configured to perform any of the methods described herein, or to manufacture a computer system or GPU comprising any apparatus described herein. An integrated circuit definition dataset may be, for example, an integrated circuit description.

Therefore, there may be provided a method of manufacturing, at an integrated circuit manufacturing system, a decompression and/or compression hardware block as described herein. Furthermore, there may be provided an integrated circuit definition dataset that, when processed in an integrated circuit manufacturing system, causes the method of manufacturing a decompression and/or compression hardware block to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS® and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

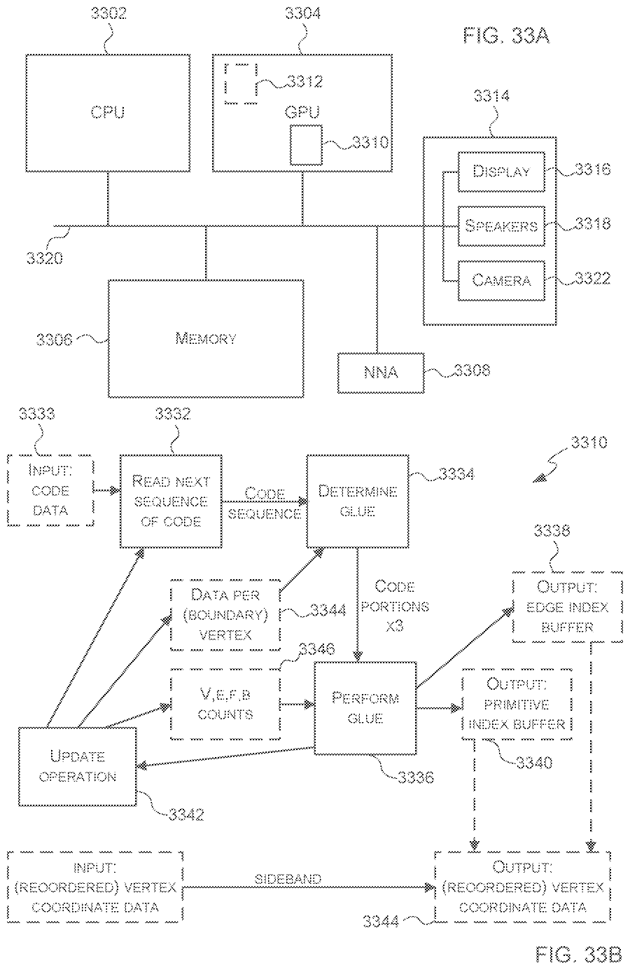

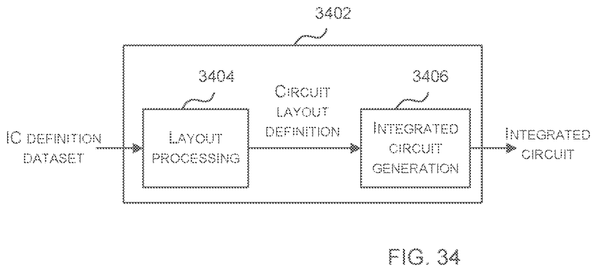

An example of processing an integrated circuit definition dataset at an integrated circuit manufacturing system so as to configure the system to manufacture a decompression and/or compression hardware block will now be described with respect to FIG. 34.

FIG. 34 shows an example of an integrated circuit (IC) manufacturing system 3402 which is configured to manufacture a decompression and/or compression hardware block as described in any of the examples herein. In particular, the IC manufacturing system 3402 comprises a layout processing system 3404 and an integrated circuit generation system 3406. The IC manufacturing system 3402 is configured to receive an IC definition dataset (e.g. defining a decompression and/or compression hardware block as described in any of the examples herein), process the IC definition dataset, and generate an IC according to the IC definition dataset (e.g. which embodies a decompression and/or compression hardware block as described in any of the examples herein). The processing of the IC definition dataset configures the IC manufacturing system 3402 to manufacture an integrated circuit embodying a decompression and/or compression hardware block as described in any of the examples herein.

The layout processing system 3404 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 3404 has determined the circuit layout it may output a circuit layout definition to the IC generation system 3406. A circuit layout definition may be, for example, a circuit layout description.

The IC generation system 3406 generates an IC according to the circuit layout definition, as is known in the art. For example, the IC generation system 3406 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 3406 can use to form a suitable mask for use in generating an IC.

The different processes performed by the IC manufacturing system 3402 may be implemented all in one location, e.g. by one party. Alternatively, the IC manufacturing system 3402 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a decompression and/or compression hardware block without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 34 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 34, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. A method of compressing meshlet topology data, comprising:
(i) selecting a starting vertex in a meshlet;
(ii) create an encoding comprising data identifying a glue type of the starting vertex and data indicating a number of connected vertices, wherein the glue type of a vertex defines a relative arrangement of the vertex and the connected vertices and wherein each connected vertex is connected to the starting vertex by an edge;
(iii) selecting a next glue vertex in the meshlet;
(iv) for the next glue vertex, appending to the encoding, one or more of: data identifying the next glue vertex; data identifying a glue type of the next glue vertex and data indicating a number of new connected vertices, wherein each new connected vertex is connected to the new glue vertex by an edge; and
(v) repeating steps (iii) and (iv) until all the vertices and edges of the meshlet are included in the encoding.

2. The method according to claim 1, wherein a next glue vertex in the meshlet is selected using pre-defined selection rules.

3. The method according to claim 1, further comprising:
appending a pre-defined termination sequence to the encoding.

4. The method according to claim 1, further comprising:
determining whether the meshlet satisfies pre-defined termination criteria; and
in response to determining that the meshlet does not satisfy the pre-defined termination criteria, appending a pre-defined termination sequence to the encoding.

5. The method according to claim 4, further comprising:
in response to determining that the meshlet satisfies the pre-defined termination criteria, outputting the encoding without appending a termination sequence to the encoding.

6. The method according to claim 1, wherein the glue type of the starting vertex is either an interior initial vertex with three or more connected vertices or a boundary initial vertex with two or more connected vertices.

7. The method according to claim 1, wherein the glue type of a next glue vertex is one of:
an interior glue vertex with no new connected vertices;
an interior glue vertex with one or more new connected vertices;
a boundary glue vertex with one or more new connected vertices added on the left; and
a boundary glue vertex with one or more new connected vertices added on the right.

8. The method according to claim 1, further comprising:
(vi) storing the encoding;
(vii) selecting a different starting vertex and repeating steps (ii)-(vi) for the different starting vertex;
(viii) selecting a shortest stored encoding for the meshlet.

9. The method according to claim 1, wherein the meshlet is homeomorphic to the topologically closed unit disc.

10. The method according to claim 1, further comprising, prior to selecting a starting vertex in a meshlet:
sub-dividing a complex meshlet into a plurality of meshlets, wherein the complex meshlet is not homeomorphic to the topologically closed unit disc and each of the plurality of meshlets is homeomorphic to the topologically closed unit disc; and
performing steps (i)-(v) for each of the plurality of meshlets.

11. The method according to claim 1, wherein the method is implemented in an offline processing by a computing device.

12. A method of decompressing compressed meshlet topology data, comprising:
(i) reading a first sequence of bits from an encoding of a meshlet;
(ii) determining, from the sequence of bits, a glue type of a starting vertex and data indicating a number of connected vertices, wherein the glue type of a vertex defines a relative arrangement of the vertex and the connected vertices and wherein each connected vertex is connected to the starting vertex by an edge;
(iii) adding the identified number of connected vertices to the starting vertex to form a portion of the meshlet, the portion of the meshlet comprising a plurality of primitives, and storing intermediate data for the portion of the meshlet;
(iv) reading a next sequence of bits from the encoding;
(v) determining, from the sequence of bits and the intermediate data, a glue vertex in the portion of the meshlet, a glue type of the glue vertex and data indicating a number of new connected vertices, wherein each connected vertex is connected to the glue vertex by an edge;
(vi) adding the identified number of new connected vertices to the portion of the meshlet according to the glue type of the glue vertex, and updating intermediate data for the portion of the meshlet;
(vii) repeating steps (iv)-(vi) until the sequence or the intermediate data indicates termination; and
(viii) outputting the decompressed meshlet topology data.

13. The method according to claim 12, wherein outputting the decompressed meshlet topology data comprises:
outputting the decompressed meshlet topology data for the portion of the meshlet prior to reading a next sequence of bits from the encoding.

14. The method according to claim 12, wherein the intermediate data comprises:
a number of vertices in the portion of the meshlet;
a number of edges in the portion of the meshlet;
a number of primitives in the portion of the meshlet; and
a number of vertices on a boundary of the portion of the meshlet.

15. The method according to claim 12, wherein pre-defined selection rules are used to determine, from the sequence of bits and the intermediate data, a glue vertex in the portion of the meshlet, a glue type of the glue vertex and data indicating a number of new connected vertices.

16. The method according to claim 12, wherein the first sequence of bits comprises a pre-defined number of bits and wherein each next sequence of bits comprises a variable number of bits, wherein the number of bits in a next sequence is determined using the intermediate data.

17. The method according to claim 12, wherein the sequence of bits comprises one or more of:
one or more bits identifying a glue vertex in the portion of the meshlet;
one or more bits indicating a glue type of the glue vertex; and
one or more bits indicating a number of new connected vertices.

18. The method according to claim 12, wherein the sequence of bits comprises one or two of:
one or more bits identifying a glue vertex in the portion of the meshlet;
one or more bits indicating a glue type of the glue vertex; and
one or more bits indicating a number of new connected vertices;
wherein the method further comprises inferring one or more of an identity of the glue vertex in the portion of the meshlet, a glue type of the glue vertex and the number of new connected vertices using the intermediate data.

19. Hardware logic arranged to decompress compressed meshlet topology data, comprising:
a first hardware logic block arranged to read a first sequence of bits from an encoding of a meshlet;
a second hardware logic block arranged to determine, from the sequence of bits received from the first hardware logic block, a glue type of a starting vertex and data indicating a number of connected vertices, wherein the glue type of a vertex defines a relative arrangement of the vertex and the connected vertices and wherein each connected vertex is connected to the starting vertex by an edge;
a third hardware logic block arranged to add the identified number of connected vertices to the starting vertex to form a portion of the meshlet, the portion of the meshlet comprising a plurality of primitives, and
a fourth hardware logic block arranged to generate and store intermediate data for the portion of the meshlet,
wherein the first hardware logic block is further arranged to read a next sequence of bits from the encoding, the second hardware logic block is further arranged to determine, from the next sequence of bits and the intermediate data, a glue vertex in the portion of the meshlet, a glue type of the glue vertex and data indicating a number of new connected vertices, wherein each connected vertex is connected to the glue vertex by an edge, the third hardware logic block is further arranged to add the identified number of new connected vertices to the portion of the meshlet according to the glue type of the glue vertex, and the fourth hardware logic block is further arranged to generate and store updated intermediate data for the portion of the meshlet.

20. The hardware logic according to claim 19, wherein the third hardware logic block is further arranged to output the decompressed meshlet topology data.
